(19) United States
(12) Patent Application Publication
(10) Pub. No.: US 2026/0162213 A1
(43) Pub. Date: Jun. 11, 2026

(54) ELECTRONIC DEVICE FOR GENERATING CORRECTED IMAGE, AND OPERATION METHOD OF THE ELECTRONIC DEVICE

(71) Applicant: SAMSUNG ELECTRONICS CO., LTD., Suwon-si (KR)

(72) Inventors: Guiwon SEO, Suwon-si (KR); Beomjoon KIM, Suwon-si (KR); Jongho KIM, Suwon-si (KR); Jonghwan KIM, Suwon-si (KR)

(73) Assignee: SAMSUNG ELECTRONICS CO., LTD., Suwon-si (KR)

(21) Appl. No.: 19/178,362

(22) Filed: Apr. 14, 2025

Related U.S. Application Data
(63) Continuation of application No. PCT/KR2025/004760, filed on Apr. 8, 2025.

(30) Foreign Application Priority Data
Apr. 15, 2024 (KR) 10-2024-0050199

(51) Int. Cl. G06T 3/04; G06T 3/40; G06T 5/20; G06T 7/246; G06T 7/50; G06T 7/62; G06T 11/00; G06V 10/46

(52) U.S. Cl. CPC G06T 3/04; G06T 3/40; G06T 5/20; G06T 7/246; G06T 7/50; G06T 7/62; G06T 11/00; G06V 10/462; G06T 2210/36

(57) ABSTRACT

An electronic device for generating a corrected image, including: memory storing at least one instruction; and at least one processor comprising a processing circuitry; wherein the at least one processor is configured to individually or collectively execute the at least one instruction stored in the memory, causes the electronic device to: obtain an input image corresponding to a first area and a second area adjacent to the first area, and a frame image corresponding to the second area; based on the input image and the frame image, generate a masking map including information about an object of interest displayed in the second area of the input image; and generate the corrected image based on the masking map by adding the input image and the frame image, wherein the corrected image includes the input image in the first area and including the object of interest and the frame image in the second area.

### CROSS-REFERENCE TO RELATED APPLICATIONS

This application is a continuation of International Application No. PCT/KR 2025/004760 designating the United States, filed on Apr. 8, 2025, in the Korean Intellectual Property Receiving Office and claiming priority to Korean Patent Application No. 10-2024-0050199, filed on Apr. 15, 2024, in the Korean Intellectual Property Office, the disclosures of each of which are incorporated by reference herein in their entireties.

### BACKGROUND

### 1. Field

The disclosure relates to an electronic device and an operation method of the electronic device, and more particularly, to an electronic device for generating a corrected image, and an operation method of the electronic device.

### 2. Description of Related Art

Electronic devices may provide users with diverse user experiences when providing images.

For example, when an image is provided using an electronic device, the image may be provided to the user by displaying a frame image, such as a black image, or an image such as a picture frame or a window frame, around the image. Accordingly, it may be desirable to increase the immersion, with respect to provided images, of users when using electronic devices.

### SUMMARY

In accordance with an aspect of the disclosure, an electronic device for generating a corrected image includes: memory storing at least one instruction; and at least one processor comprising a processing circuitry; wherein the at least one processor is configured to individually or collectively execute the at least one instruction stored in the memory to: obtain an input image corresponding to a first area and a second area adjacent to the first area, and a frame image corresponding to the second area; based on the input image and the frame image, generate a masking map including information about an object of interest displayed in the second area of the input image; and generate the corrected image based on the masking map by adding the input image and the frame image, wherein the corrected image includes the input image in the first area and including the object of interest and the frame image in the second area.

The electronic device may further include an image display including a display area, the first area and the second area may be included in the display area, and the at least one instruction may further cause the electronic device to display the generated corrected image in the display area.

The at least one instruction may further cause the electronic device to: based on the input image, obtain a depth map including depth information associated with the input image; based on the input image, obtain a saliency map including saliency information associated with the input image; and based on the frame image, the depth map, and the saliency map, extract the object of interest from the input image.

The at least one instruction may further cause the electronic device to: based on the saliency map and the frame image, extract an object from among at least one object included in the input image as an object-of-interest candidate based on determining that a saliency value of the object is greater than a predetermined first value and that the object corresponds to the second area; and based on the depth map, extract the object-of-interest candidate as the object of interest based on determining that a depth value of the object-of-interest candidate is greater than a predetermined second value.

The first area may have a first resolution and the input image may have an input resolution, and the at least one instruction may further cause the electronic device to: based on the object of interest, calculate a reduction ratio for lowering the input resolution of the input image; and generate the masking map based on the reduction ratio, the frame image, and the object of interest.

The at least one instruction may further cause the electronic device to: based on the reduction ratio, generate a reduced input image by lowering the input resolution of the input image; and generate the corrected image by adding the reduced input image and the frame image based on the masking map.

The input resolution may be greater than the first resolution, and a resolution of the reduced input image may be equal to or greater than the first resolution.

The masking map may be generated to mask each of the reduced input image and the frame image, in order to generate the corrected image including the reduced input image in the first area and including the frame image in the second area.

The at least one instruction may further cause the electronic device to: based on the input image, obtain motion information by estimating a movement of the input image; based on the obtained motion information, extract a moving object from the input image; calculate an expected location of the moving object in a next frame; and based on determining that the calculated expected location is included in the second area, generate a movement corrected image including the moving object positioned at the expected location on the second area of the corrected image, based on the corrected image and the moving object.

The at least one instruction may further cause the electronic device to: calculate a size of at least one object included in the input image; and based on the motion information and the size of the at least one object, extract an object from among the at least one object as the moving object based on determining that a size of the object is smaller than a predetermined third value.

In accordance with an aspect of the disclosure, a method for generating a corrected image using an electronic device includes: obtaining an input image corresponding to a first area and a second area adjacent to the first area and a frame image corresponding to the second area; based on the input image and the frame image, generating a masking map including information about an object of interest displayed in the second area of the input image; and generating the corrected image based on the masking map by adding the input image and the frame image, wherein the corrected image includes the input image in the first area, and including the object of interest and the frame image in the second area.

The method may further include displaying the generated corrected image on a display area using an image display including the display area, and the first area and the second area may be included in the display area.

The method may further include: based on the input image, obtaining a depth map including depth information associated with the input image; based on the input image, obtaining a saliency map including saliency information associated with the input image; and based on the frame image, the depth map, and the saliency map, extracting the object of interest from the input image.

The extracting of the object of interest may further include: based on the saliency map and the frame image, extracting an object from among at least one object included in the input image as an object-of-interest candidate based on determining that a saliency value of the object is greater than a predetermined first value and that the object corresponds to the second area; and based on the depth map, extracting the object-of-interest candidate as the object of interest based on determining that a depth value of the object-of-interest candidate is greater than a predetermined second value.

The first area may have a first resolution, and the input image has an input resolution, the method may further include, based on the object of interest, calculating a reduction ratio for lowering the input resolution of the input image, and the masking map may be generated based on the reduction ratio, the frame image, and the object of interest.

The method may further include, based on the reduction ratio, generating a reduced input image by lowering the input resolution of the input image, and in the generating of the corrected image, the corrected image may be generated by adding the reduced input image and the frame image, based on the masking map.

The masking map may be generated to mask each of the reduced input image and the frame image, in order to generate the corrected image including the reduced input image on the first area and including the frame image on the second area.

The method may further include: based on the input image, obtaining motion information by estimating a movement of the input image; based on the obtained motion information, extracting a moving object from the input image; calculating an expected location of the moving object in a next frame; and based on determining that the calculated expected location is included in the second area, generating a movement corrected image including the moving object positioned at the expected location on the second area of the corrected image, based on the corrected image and the moving object.

The extracting of the moving object may include: calculating a size of at least one object included in the input image; and based on the motion information and the size of the at least one object, extracting an object from among the at least one object as the moving object based on determining that a size of the object is smaller than a predetermined third value.

In accordance with an aspect of the disclosure, a computer-readable recording medium has recorded thereon a computer program including instructions, which, when executed by at least one processor of an electronic device for generating a corrected image, causes the electronic device to: obtain an input image corresponding to a first area and a second area adjacent to the first area and a frame image corresponding to the second area; based on the input image and the frame image, generate a masking map including information about an object of interest displayed in the second area of the input image; and generate the corrected image based on the masking map by adding the input image and the frame image, wherein the corrected image includes the input image in the first area, and including the object of interest and the frame image in the second area.

The technical problems to be addressed in this disclosure are not limited to the above-mentioned technical problems, and other technical problems not mentioned will be clearly understood by a person skilled in the art to which the disclosure pertains from the following description.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view for explaining an operation of an electronic device according to an embodiment of the disclosure.

FIG. 2 is a block diagram for explaining a structure of the electronic device according to an embodiment of the disclosure.

FIG. 3 is a flowchart of an operation of the electronic device, according to an embodiment of the disclosure.

FIG. 4 is a flowchart for explaining an operation of the electronic device according to an embodiment of the disclosure.

FIG. 5 is a flowchart of an operation of generating a masking map, according to an embodiment of the disclosure.

FIG. 6A is a view for explaining a saliency map according to an embodiment of the disclosure.

FIG. 6B is a view for describing an operation of extracting an object-of-interest candidate, according to an embodiment of the disclosure.

FIG. 7 is a view for explaining a depth map according to an embodiment of the disclosure.

FIG. 8 is a view for explaining a reduction ratio and a reduced input image according to an embodiment of the disclosure.

FIG. 9 is a view for explaining a masking map according to an embodiment of the disclosure.

FIG. 10 is a view for explaining a corrected image including an input image on a first area and including an object of interest and a frame image on a second area, according to an embodiment of the disclosure.

FIG. 11 is a flowchart of an operation of generating a corrected image by adding a reduced input image to a frame image, based on a masking map, according to an embodiment of the disclosure.

FIG. 12 is a flowchart of an operation of generating a movement corrected image including a moving object, according to an embodiment of the disclosure.

FIG. 13 is a flowchart of an operation of extracting a moving object according to the size of an object included in an input image, according to an embodiment of the disclosure.

FIG. 14 is a block diagram for explaining an operation of generating a movement corrected image including a moving object, according to an embodiment of the disclosure.

FIG. 15 is a view for explaining an operation of extracting a moving object from an input image, based on motion information associated with the input image, according to an embodiment of the disclosure.

FIG. 16 is a view for explaining an operation of calculating an expected location of a moving object in a next frame, according to an embodiment of the disclosure.

FIG. 17 is a view for explaining a movement corrected image including a moving object, according to an embodiment of the disclosure.

FIG. 18 is a view for explaining an operation of an electronic device according to an embodiment of the disclosure.

### DETAILED DESCRIPTION

Hereinafter, examples of terms used herein briefly described, and then embodiments of the disclosure are described in detail.

Although general terms are used for describing the disclosure in consideration of the functions thereof, these general terms may vary according to intentions of one of ordinary skill in the art, legal precedents, the advent of new technologies, and the like. Terms arbitrarily selected to be used herein may also be used in a specific case. For example, the meanings of some terms may be given in the detailed description of an embodiment of the disclosure. Hence, the terms must be defined based on their meanings and the contents of the entire disclosure, not by simply stating the terms.

An expression used in the singular may encompass the expression of the plural, unless it has a clearly different meaning in the context. Unless otherwise defined, all terms (including technical and scientific terms) used herein may have the same meaning as commonly understood by one of ordinary skill in the art to which this disclosure belongs.

The terms “comprises” and/or “comprising” or “includes” and/or “including” used herein specify the presence of stated elements, but do not preclude the presence or addition of one or more other elements. The terms “unit”, “-er (-or)”, and “module” when used herein may refer to a unit in which at least one function or operation is performed, and may be implemented as hardware, software, or a combination of hardware and software.

The expression “configured to (or set to)” used herein may be used interchangeably with, for example, “suitable for”, “having the capacity to”, “designed to”, “adapted to”, “made to”, or “capable of”, according to situations. The expression “configured to (or set to)” may not only necessarily refer to “specifically designed to” in terms of hardware. Instead, in some situations, the expression “system configured to” may refer to a situation in which the system is “capable of” together with another device or parts. For example, the phrase “a processor configured (or set) to perform A, B, and C” may mean a dedicated processor (such as an embedded processor) for performing a corresponding operation, or a generic-purpose processor (such as a central processing unit (CPU) or an application processor (AP)) that can perform a corresponding operation by executing one or more software programs stored in memory.

When an element (e.g., a first element) is “coupled to” or “connected to” another element (e.g., a second element), the first element may be directly coupled to or connected to the second element, or, unless otherwise described, a third element may exist therebetween.

Embodiments of the disclosure are described in detail herein with reference to the accompanying drawings so that this disclosure may be more easily performed by one of ordinary skill in the art to which the disclosure pertains. An embodiment of the disclosure may, however, be embodied in many different forms and should not be construed as being limited to the embodiment set forth herein. In the drawings, some elements may be omitted for simplicity of explanation, and like numbers may refer to like elements throughout.

Example embodiments of the disclosure are described more fully hereinafter with reference to the accompanying drawings.

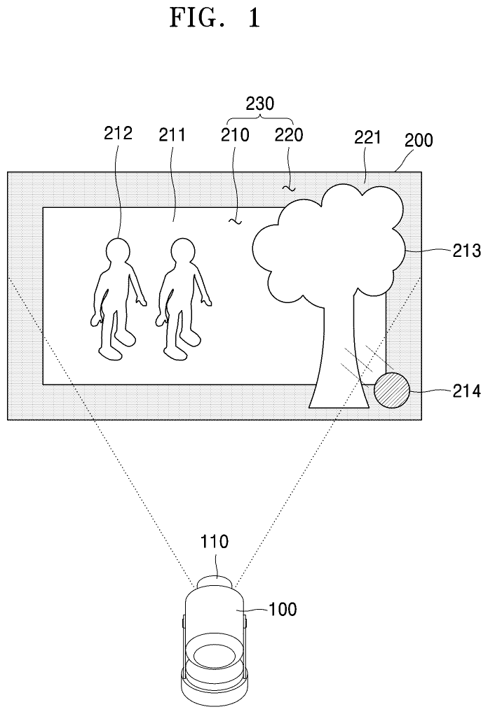

FIG. 1 is a view for explaining an operation of an electronic device 100 according to an embodiment of the disclosure.

Referring to FIG. 1, according to an embodiment of the disclosure, the electronic device 100 may be a device that provides an image 200 to a user by displaying the image 200. The electronic device 100 may be a device that projects the image 200 onto a space. The electronic device 100 may provide the image 200 to a user using the electronic device 100, by projecting the image 200 onto a space.

FIG. 1 illustrates an example in which the electronic device 100 is a projector for projecting the image 200 onto a space. According to an embodiment of the disclosure, an area on the space to which the image 200 is projected may be referred to as a projection area 230. The projection area 230 may be an area where the image 200 projected by the electronic device 100 is displayed. According to an embodiment of the disclosure, the projection area 230 may be, may include, or may be included in a screen included in the space, but embodiments are not limited thereto. For example, in some embodiments, the projection area may be, may include, or may be included in an object, a wall, a ceiling, etc. included in the space.

According to an embodiment of the disclosure, the electronic device 100 may be a stationary projector fixed to a specific location or a mobile projector that may be placed at a location within a space.

FIG. 1 illustrates an example in which the electronic device 100 has a circular shape. However, embodiments are not limited thereto. The electronic device 100 may have any shape, such as for example a rectangle.

FIG. 1 illustrates the electronic device 100 as being positioned at a specific location facing the projection area 230. However, embodiments are not limited thereto. According to a method in which the electronic device 100 provides the image 200, a relationship between the location at which the electronic device 100 is placed and the projection area 230 may be determined. For example, the projection area 230 may be positioned in a direction which faces upward from the location at which the electronic device 100 is placed, which may be referred to as an upward-facing direction.

According to an embodiment of the disclosure, the electronic device 100 may include an image display 110 that projects the image 200. The electronic device 100 may provide the image 200 to a user through the image display 110.

However, embodiments are not limited thereto. The electronic device 100 may have any of various shapes of electronic devices, such as a television, a mobile device, a smartphone, a laptop computer, a desktop computer, a tablet personal computer (PC), a digital broadcasting terminal, and a wearable device. According to an embodiment of the disclosure, the electronic device 100 may be implemented as at least one from among electronic devices of various shapes, and may display the image 200 through the image display 110 to provide the image 200 to a user 400.

According to an embodiment of the disclosure, the image display 110 may include a display area. According to an embodiment of the disclosure, the image 200 shown in FIG. 1 may be projected through the image display 110 and displayed on the projection area 230. According to an embodiment of the disclosure, the size of the projection area 230 may be greater than a size of the display area. As a distance between the image display 110 and the projection area 230 increases, the size of the projection area 230 may become larger.

However, embodiments are not limited thereto. When the electronic device 100 is an electronic device including a display displaying an image on a display area, such as a television, a mobile device, a smartphone, a laptop computer, a desktop computer, a tablet PC, a digital broadcasting terminal, and a wearable device, an image displayed on the display area may be provided to a user.

According to an embodiment of the disclosure, the projection area 230 may include a first projection area 210 and a second projection area 220. The display area may include a first area and a second area.

According to an embodiment of the disclosure, the projection area 230 on the space may be an area corresponding to the display area of the image display 110. The first projection area 210 on the space may be an area corresponding to the first area of the image display 110. The second projection area 220 on the space may be an area corresponding to the second area of the image display 110.

For convenience of explanation, the projection area 230 illustrated in FIG. 1 may be described as a display area 230. The first projection area 210 is described as a first area 210. The second projection area 220 is described as a second area 220.

However, when the electronic device 100 is a projector that projects the image 200, an image displayed on the first area of the image display 110 may be projected on the first projection area 210, and an image displayed on the second area of the image display 110 may be projected on the second projection area 220 and provided to the user.

According to an embodiment of the disclosure, a first image 211 may be displayed on the first area 210. A second image 221 may be displayed on the second area 220. According to an embodiment of the disclosure, the first image 211 may be an image generated based on an input image. The second image 221 may be an image generated based on a frame image.

According to an embodiment of the disclosure, the input image may be an image corresponding to the first area 210 and the second area 220 adjacent to the first area 210. According to an embodiment of the disclosure, the frame image may be an image corresponding to the second area 220. The frame image may be an image that is displayed around an input image and serves as the background of the input image.

According to an embodiment of the disclosure, because the second image 221 corresponding to the frame image may be displayed on the second area 220, a portion of the input image corresponding to the second area 220 may not be displayed. A portion of the first image corresponding to the first area 210 may be displayed on the first area 210.

However, embodiments are not limited thereto. The first image 211 may be an image having a resolution which is adjusted so that the input image corresponds to the first area 210. According to an embodiment of the disclosure, the first image 211 may be an image having a resolution which is adjusted so that the entire input image is displayed on the first area 210. The first image 211 may also be an image having a resolution which is adjusted so that a portion of the input image corresponding to the second area 220 is displayed on the first area 210.

According to an embodiment of the disclosure, the electronic device 100 may generate a corrected image including the first image 211, which may include at least a portion of the input image corresponding to the first area 210, and the second image 221, which may be generated based on the frame image. The electronic device 100 may project the corrected image using the image display 110 to provide the corrected image to a user.

According to an embodiment of the disclosure, the electronic device 100 may display the first image 211 generated based on the input image, and may display the second image 221 generated based on the frame image on the second area 220 around the first area 210 to thereby provide the first image 211 and the second image 221 to the user. Accordingly, the electronic device 100 may provide a high sense of immersion to a user using the electronic device 100.

According to an embodiment of the disclosure, the input image may be an image including a first object 212, a second object 213, and a background image. The first object 212 may be an object image corresponding to the first area 210. The second object 213 may be an object image of which at least a portion corresponds to the second area 220.

According to an embodiment of the disclosure, the electronic device 100 may obtain a saliency map including saliency information associated with the input image, based on the input image. The electronic device 100 may obtain a depth map including depth information associated with the input image, based on the input image.

Examples of the saliency map and the depth map a described in greater detail below.

According to an embodiment of the disclosure, the electronic device 100 may obtain an object of interest from the input image, based on the saliency map, the depth map, and the frame image. The object of interest may be an object having high saliency for the user, or with respect to the user, among the second object 213 corresponding to the second area 220. The object of interest may also be an object with a high depth value, (e.g. an object judged or otherwise determined to be close to the user), from among objects with high saliency for the user.

In this case, the electronic device 100 may generate the second image 221 based on the frame image and the object of interest. The electronic device 100 may generate a corrected image including the first image 211, which may include at least a portion of the input image corresponding to the first area 210, and the second image 221, which may include at least a portion of the object of interest corresponding to the second area 220. The electronic device 100 may project the corrected image through the image display 110 to provide the corrected image to the user.

According to an embodiment of the disclosure, the electronic device 100 may display, on the first area 210, the first image 211 generated based on at least the portion of the input image corresponding to the first area 210. In this case, the first image 211 may include a portion of the object of interest corresponding to the first area 210. According to an embodiment of the disclosure, when all of the object of interest corresponds to the second area 220, the first image 211 may not include the object of interest.

According to an embodiment of the disclosure, the electronic device 100 may display, on the second area 220, the second image 221 generated based on the frame image and the portion of the object of interest corresponding to the second area 220.

According to an embodiment of the disclosure, because the electronic device 100 may display the object of interest having a high saliency for the user and judged to be close to the user, on the second area 220 using the corrected image, the electronic device 100 may provide the image 200 having a stereoscopic effect to the user.

However, embodiments are not limited thereto. Even when the object of interest is extracted from the input image, when the resolution of the input image is adjusted to correspond to the first area 210, the second image 221 may include only the frame image.

According to an embodiment of the disclosure, the input image may include a third object 214. A position of the third object 214 may move over a plurality of frames.

According to an embodiment of the disclosure, the electronic device 100 may obtain motion information by estimating a movement of the input image, based on the input image. The electronic device 100 may extract the third object 214 from the input image, based on the obtained motion information. In addition, the electronic device 100 may also extract, as a moving object, a third object 214 having a size that is larger than a predetermined value from the third object 214.

According to an embodiment of the disclosure, the electronic device 100 may calculate a location of the moving object in the next frame. The electronic device 100 may generate the second image 221 including the moving object in the next frame, based on the calculated location of the moving object being in the second area 220.

According to an embodiment of the disclosure, the electronic device 100 may generate the first image 211, which may include at least a portion of the input image corresponding to the first area 210, and may generate a movement corrected image including the frame image and the portion of the moving object corresponding to the second area 220. However, embodiments are not limited thereto, and the movement corrected image may include the frame image, the portion of the object of interest corresponding to the second area 220, and the portion of the moving object corresponding to the second area 220.

According to an embodiment of the disclosure, the electronic device 100 may project the movement corrected image through the image display 110 to provide the movement corrected image to the user.

According to an embodiment of the disclosure, because the electronic device 100 may display the object of interest having a high saliency for the user and judged to be close to the user, on the second area 220 through the corrected image, the electronic device 100 may provide the image 200 having a stereoscopic effect to the user.

Effects obtainable from the disclosure are not limited to the aforementioned technical effects, and other effects not mentioned will be clearly understood by a person skilled in the art to which the disclosure pertains from the following description.

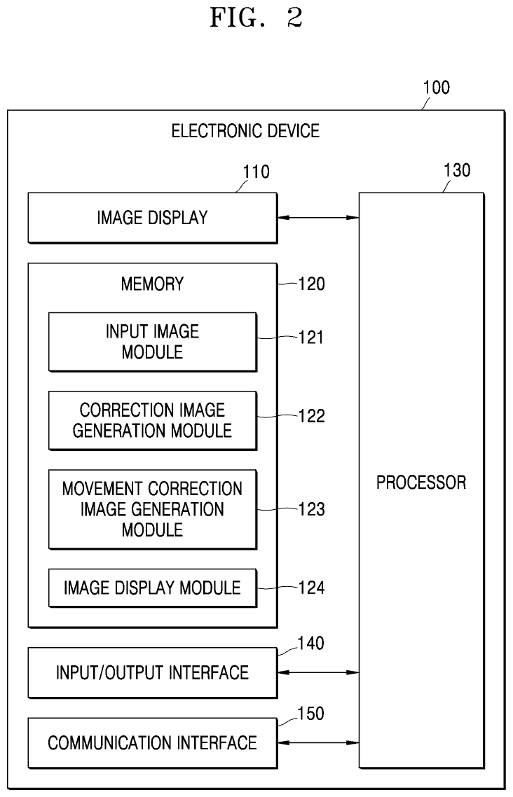

FIG. 2 is a block diagram for explaining a structure of the electronic device 100 according to an embodiment of the disclosure.

Referring to FIGS. 1 and 2, according to an embodiment of the disclosure, the electronic device 100 may include the image display 110, memory 120, at least one processor 130, an input/output interface 140, and a communication interface 150. However, the components illustrated in FIG. 2 are only an example.

According to an embodiment of the disclosure, the electronic device 100 may be implemented by more or less components than those illustrated in FIG. 2. The image display 110, the memory 120, the at least one processor 130, the input/output interface 140, and the communication interface 150 may be electrically and/or physically connected to each other.

According to an embodiment of the disclosure, the image display 110 may project the image 200 by generating light for displaying the image 200. The image display 110 may also be referred to as a projector or a display. The image display 110 may include various components, such as a light source, a projection lens, and a reflector.

According to an embodiment of the disclosure, the image display 110 may project the image 200 by generating light using various projection methods, for example, a cathode-ray tube (CRT) method, a liquid crystal display (LCD) method, a digital light processing (DLP) method, and a laser method.

According to an embodiment of the disclosure, the image display 110 may include various types of light sources. For example, the image display 110 may include at least one light source among a lamp, an LED, and a laser.

According to an embodiment of the disclosure, the image display 110 may output the image 200 at a 4:3 screen ratio, a 5:4 screen ratio, a 16:9 wide screen ratio, etc. according to the purpose of the electronic device 100 or the user's settings. The image display 110 may output the image 200 with various resolutions, such as WVGA (854*480), SVGA (800*600), XGA (1024*768), WXGA (1180*720), WXGA (1180*800), SXGA (1180*1024), UXGA (1600*1100), Full HD (1920*1080), and UHD (3840*2160), according to a determined screen ratio.

According to an embodiment of the disclosure, the memory 120 may store at least one of instructions, a data structure, and a program code readable by the at least one processor 130. According to an embodiment of the disclosure, the memory 120 may be at least one memory. According to a disclosed embodiment, operations performed by the at least one processor 130 may be implemented by executing the instructions or codes of a program stored in the memory 120.

According to an embodiment of the disclosure, the memory 120 may include at least one of a flash type memory, a hard disk type memory, a multimedia card micro type memory, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), mask ROM, flash ROM, a hard disk drive (HDD), and a solid state driver (SSD).

According to an embodiment of the disclosure, the memory 120 may not be a separate component, and may for example be included in the at least one processor 130.

The memory 120 may store instructions or program codes for performing functions or operations of the electronic device 100. The instructions, algorithm, data structure, program code, and application program stored in the memory 120 may be implemented in, for example, programming or scripting languages such as C, C++, Java, python, assembler, and the like.

According to an embodiment of the disclosure, the memory 120 may store various types of modules that may be used to generate the corrected image or the movement corrected image through the image display 110 and provide the corrected image or the movement corrected image to the user.

According to an embodiment of the disclosure, the memory 120 may include an input image module 121, a corrected image generation module 122, a movement corrected image generation module 123, and an image display module 124.

However, the modules illustrated in FIG. 2 are only an example, and in some embodiments, more or fewer modules than those shown in FIG. 2 may be stored in the memory 120.

According to an embodiment of the disclosure, a module included in the memory 120 may refer to a unit in which a function or operation performed by the at least one processor 130 is processed. The module included in the memory 120 may be implemented as software, such as instructions, an algorithm, a data structure, or program code.

According to an embodiment of the disclosure, the input image module 121 may include instructions or program code related to an operation or function of obtaining an input image for generating the image 200, which is to be displayed through the electronic device 100.

According to an embodiment of the disclosure, the at least one processor 130 may obtain an input image for generating the image 200, which is to be displayed through the electronic device 100, by executing the instructions or program code of the input image module 121.

According to an embodiment of the disclosure, the input image module 121 may include instructions or program code related to an operation or function of obtaining a frame image for generating the image 200, which is to be displayed through the electronic device 100.

According to an embodiment of the disclosure, the at least one processor 130 may obtain a frame image for generating the image 200, which is to be displayed through the electronic device 100, by executing the instructions or program code of the input image module 121.

According to an embodiment of the disclosure, the input image module 121 may include instructions or program code related to an operation or function of obtaining at least one of the input image or the frame image, from an external electronic device through the input/output interface 140.

According to an embodiment of the disclosure, the at least one processor 130 may obtain at least one of the input image and the frame image from the external electronic device, by executing the instructions or program code of the input image module 121.

The input image module 121 may include instructions or program code related to an operation or function of obtaining at least one of the input image and the frame image from an external server through the communication interface 150.

According to an embodiment of the disclosure, the at least one processor 130 may obtain at least one of the input image and the frame image from the external server through the communication interface 150, by executing the instructions or program code of the input image module 121.

However, embodiments are not limited thereto, and the at least one processor 130 may obtain an input image or frame image pre-stored in the memory 120, by executing the instructions or program code of the input image module 121.

According to an embodiment of the disclosure, the corrected image generation module 122 may include instructions or program code related to an operation or function of generating the corrected image.

According to an embodiment of the disclosure, the at least one processor 130 may generate the corrected image by executing the instructions or program code of the corrected image generation module 122.

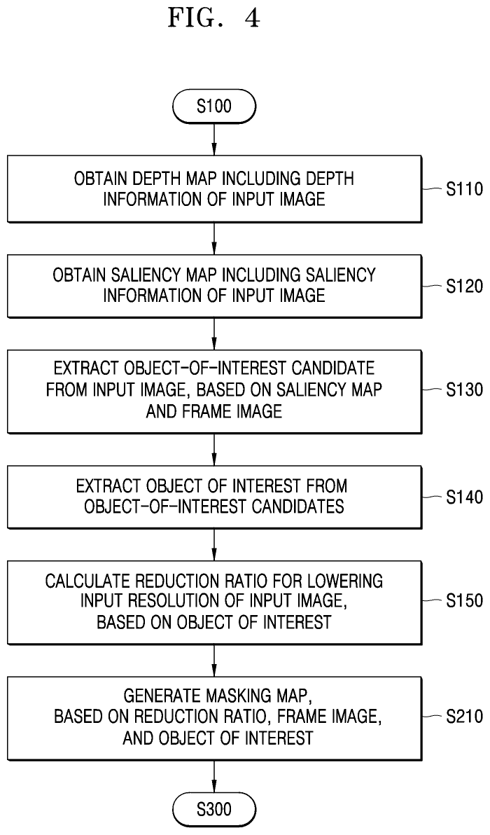

Examples of the corrected image generation module 122 and an operation of generating the corrected image are be described below with reference to FIGS. 4 through 11.

According to an embodiment of the disclosure, the movement corrected image generation module 123 may include instructions or program code related to an operation or function of generating the movement corrected image.

According to an embodiment of the disclosure, the at least one processor 130 may generate the movement corrected image by executing the instructions or program code of the movement corrected image generation module 123.

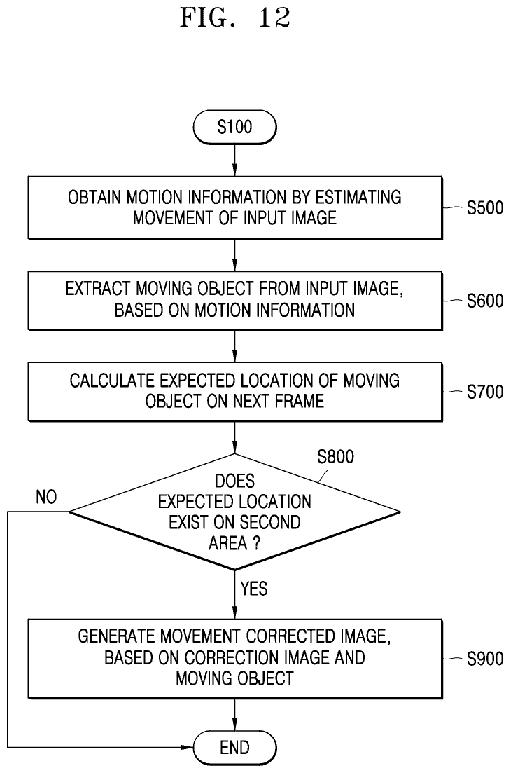

Examples of the movement corrected image generation module 123 are described below with reference to FIGS. 12 through 17.

According to an embodiment of the disclosure, the image display module 124 may include instructions or program code related to an operation or function of controlling the image display 110 to display the corrected image or the movement corrected image.

According to an embodiment of the disclosure, the at least one processor 130 may control the image display 110 to display the corrected image or the movement corrected image, by executing the instructions or program code of the image display module 124.

According to an embodiment of the disclosure, the at least one processor 130 may control a series of processes so that the electronic device 100 operates according to embodiments described below, and may include one processor or a plurality of processors.

According to an embodiment of the disclosure, the at least one processor 130 may include, but is not limited to, at least one of a central processing unit, a microprocessor, a graphics processing unit, an application processor, application specific integrated circuits (ASICs), digital signal processors (DSPs), digital signal processing devices (DSPDs), programmable logic devices (PLDs), field programmable gate arrays (FPGAs), a communication processor, a neural processing unit, or an artificial intelligence (AI) dedicated processor designed with a hardware structure specialized for training and processing an AI model.

According to an embodiment of the disclosure, when one processor or a plurality of processors included in the at least one processor 130 are AI-only processors, the AI-only processors may be designed in a hardware structure specialized for processing a specific AI model.

According to an embodiment of the disclosure, the at least one processor 130 may include circuitry such as a system on chip (SoC) or an integrated circuit (IC).

According to an embodiment of the disclosure, the at least one processor 130 may execute various types of modules stored in the memory 120. The at least one processor 130 may execute at least one instruction included in the various types of modules stored in the memory 120. By executing a program or at least one instruction stored in the memory 120, the at least one processor 130 may process data according to predefined operation rules or an AI model.

According to an embodiment of the disclosure, the at least one processor 130 may execute at least one of the input image module 121, the corrected image generation module 122, the movement corrected image generation module 123, and the image display module 124.

According to an embodiment of the disclosure, the at least one processor 130 may include a plurality of processors.

According to an embodiment of the disclosure, at least one of the input image module 121, the corrected image generation module 122, the movement corrected image generation module 123, and the image display module 124 may be executed by one or more of the plurality of processors.

The remaining modules among the input image module 121, the corrected image generation module 122, the movement corrected image generation module 123, and the image display module 124 may be executed by remaining processors.

According to an embodiment of the disclosure, the input/output interface 140 may receive at least one of image data or audio data from the external electronic device or the like, under the control by the at least one processor 130. The at least one processor 130 may obtain the input image from the external electronic device through the input/output interface 140.

According to an embodiment of the disclosure, the input/output interface 140 may perform an input/output operation with the external electronic device using at least one of input/output methods including a High-Definition Multimedia Interface (HDMI) port, a Digital Visual Interface (DVI), a component jack, a PC port, or a Universal Serial Bus (USB) port. However, embodiments are not limited to the aforementioned input/output methods.

According to an embodiment of the disclosure, the communication interface 150 may perform data communication with the external server or the external electronic device under the control by the at least one processor 130. The communication interface 150 may perform data communication with the external server or the external electronic devices using at least one of data communication methods including, for example, a wired LAN, a wireless LAN, Wi-Fi, Bluetooth, Zigbee, Wi-Fi Direct (WFD), infrared communication (IrDA), Bluetooth Low Energy (BLE), Near Field Communication (NFC), Wireless Broadband Internet (Wibro), World Interoperability for Microwave Access (WiMAX), a shared wireless access protocol (SWAP), Wireless Gigabit Alliance (WiGig), and RF communication.

According to an embodiment of the disclosure, the at least one processor 130 may receive the input image from the external server or the external electronic device via the communication interface 150. The at least one processor 130 may provide the corrected image or the movement corrected image to the external server or the external electronic device through the communication interface 150.

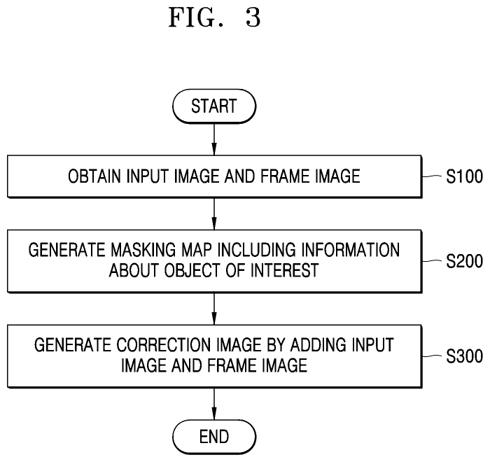

FIG. 3 is a flowchart of an example operation of the electronic device 100, according to an embodiment of the disclosure.

Referring to FIGS. 1, 2, and 3, according to an embodiment of the disclosure, an operation method of the electronic device 100 may include an operation S100 of obtaining an input image corresponding to the first area 210 and the second area 220 and a frame image corresponding to the second area 220.

In operation S100, the electronic device 100 may obtain the input image and the frame image through the input/output interface 140 or the communication interface 150.

Although the operation S100 is illustrated as a single operation in FIG. 3, embodiments are not limited thereto. For example, the input image and the frame image may be obtained in different operations.

The electronic device 100 may also use an already-obtained input image and an already-obtained frame image.

According to an embodiment of the disclosure, the operation method of the electronic device 100 may include an operation S200 of generating a masking map including information about the portion of the object of interest displayed on the second area 220, based on the input image and the frame image.

In the operation S200, the electronic device 100 may generate the masking map including the information about the portion of the object of interest displayed on the second area 220, based on the input image and the frame image.

Examples of the masking map and the operation S200 o are described below with reference to FIGS. 4 through 9.

According to an embodiment of the disclosure, the operation method of the electronic device 100 may include an operation S300 of generating a corrected image including the input image in the first area 210 and including the object of interest and the frame image in the second area 220, by adding the input image and the frame image, based on the masking map.

In the operation S300, the electronic device 100 may generate the corrected image including the input image in the first area 210 and including the object of interest and the frame image in the second area 220, by adding the input image and the frame image, based on the masking map.

Examples of the operation S300 are described below with reference to FIGS. 4, 10, and 11.

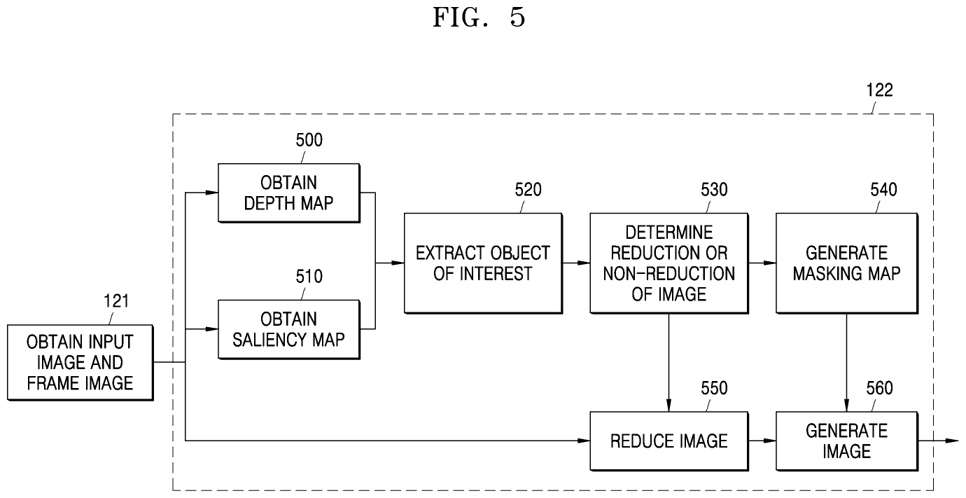

FIG. 4 is a flowchart for explaining an operation of an electronic device according to an embodiment of the disclosure. FIG. 5 is a flowchart of an operation of generating a masking map, according to an embodiment of the disclosure. Operations that are the same as those described above with reference to FIG. 3 are given the same reference numerals, and thus redundant descriptions thereof will be omitted.

Referring to FIGS. 1, 2, 4, and 5, according to an embodiment of the disclosure, the operation method of the electronic device 100 may include an operation S110 of obtaining a depth map including depth information associated with the input image, based on the input image.

According to an embodiment of the disclosure, the operation S110 may be performed after the operation S100.

In the disclosure, a depth map may refer to an image that includes information about a depth value from a reference point of view to the surface of an object. In the disclosure, a depth value may refer to a value that numerically represents information about a distance from the reference point of view to the surface of the object. According to an embodiment of the disclosure, a depth value corresponding to a surface located close to the reference point of view among the surface of the object may be greater than a depth value corresponding to a surface located far from the reference point of view among the surface of the object. According to an embodiment of the disclosure, depth information may refer to a depth value.

According to an embodiment of the disclosure, in the operation S110, the electronic device 100 may obtain a depth map including depth information, based on the input image. According to an embodiment of the disclosure, the at least one processor 130 may generate the depth map by executing the instructions or program code of the corrected image generation module 122.

According to an embodiment of the disclosure, the corrected image generation module 122 may include a depth map module 500. The depth map module 500 may include instructions or program code related to an operation or function of obtaining a depth map including depth information associated with the input image, based on the input image.

According to an embodiment of the disclosure, the depth map module 500 may include an AI model. According to an embodiment of the disclosure, the AI model included in the depth map module 500 may include a machine learning or deep learning model. According to an embodiment of the disclosure, the AI model included in the depth map module 500 may be an AI model trained to receive an image as an input and infer a depth map including depth information.

According to an embodiment of the disclosure, the at least one processor 130 may generate the depth map including the depth information, based on the input image, by executing the instructions or program code of the depth map module 500.

According to an embodiment of the disclosure, the operation method of the electronic device 100 may include an operation S120 of obtaining a saliency map including saliency information associated with the input image, based on the input image.

In the disclosure, the saliency map may refer to an image including information about a saliency value for an object or background image included in the input image. According to an embodiment of the disclosure, the saliency value may refer to a level of importance, a level of interest, etc.

According to an embodiment of the disclosure, an area with a high saliency value may be an area of high user interest or an area judged to be of high importance. An area with a low saliency value may be an area of high user interest or an area judged to be of high importance. According to an embodiment of the disclosure, saliency information may refer to a saliency value.

According to an embodiment of the disclosure, in the operation S120, the electronic device 100 may obtain a saliency map including saliency information, based on the input image. According to an embodiment of the disclosure, the at least one processor 130 may generate the saliency map by executing the instructions or program code of the corrected image generation module 122.

According to an embodiment of the disclosure, the corrected image generation module 122 may include a saliency map module 510. The saliency map module 510 may include instructions or program code related to an operation or function of obtaining a saliency map including saliency information associated with the input image, based on the input image.

According to an embodiment of the disclosure, the saliency map module 510 may include an algorithm that uses a method such as fixation prediction or salient object detection.

According to an embodiment of the disclosure, the saliency map module 510 may include an AI model. The AI model included in the saliency map module 510 may include a machine learning or deep learning model. According to an embodiment of the disclosure, the AI model included in the saliency map module 510 may be an AI model trained to receive an image as an input and infer a saliency map including saliency information.

According to an embodiment of the disclosure, the AI models respectively included in each of the depth map module 500 and the saliency map module 510 may include a convolutional neural network (CNN), a deep neural network (DNN), a recurrent neural network (RNN), a variational auto encoder (VAE), and a transformer. The AI model included in the depth map module 500 and the AI model included in the saliency map module 510 according to the disclosure are not limited to the aforementioned examples.

According to an embodiment of the disclosure, the at least one processor 130 may generate the saliency map including the saliency information, based on the input image, by executing the instructions or program code of the saliency map module 510.

According to an embodiment of the disclosure, the operation method of the electronic device 100 may include an operation of extracting an object of interest from the input image, based on the frame image, the depth map, and the saliency map.

According to an embodiment of the disclosure, in the operation of extracting the object of interest from the input image, the electronic device 100 may extract the object of interest from the input image, based on the frame image, the depth map, and the saliency map.

According to an embodiment of the disclosure, the at least one processor 130 may extract the object of interest from the input image by executing the instructions or program code of the corrected image generation module 122.

According to an embodiment of the disclosure, the corrected image generation module 122 may include an object-of-interest module 520. The object-of-interest module 520 may include instructions or program code related to an operation or function of extracting the object of interest from the input image, based on the frame image, the depth map, and the saliency map.

The at least one processor 130 may extract the object of interest from the input image, based on the frame image, the depth map, and the saliency map, by executing the instructions or program code of the object-of-interest module 520.

According to an embodiment of the disclosure, the operation of extracting the object of interest from the input image may include operation S130 of extracting an object-of-interest candidate from the input image, based on the saliency map and the frame image 300.

According to an embodiment of the disclosure, in the operation S130, the at least one processor 130 may extract the object-of-interest candidate from the input image, based on the saliency map and the frame image 300, by executing instructions or program code of an object-of-interest module 520.

According to an embodiment of the disclosure, the operation of extracting the object of interest from the input image may include operation S140 of extracting the object-of-interest candidate as the object of interest, when the object-of-interest candidate has a depth value that is larger than a predetermined second value.

According to an embodiment of the disclosure, in the operation S140, the at least one processor 130 may extract the object-of-interest candidate as the object of interest, based on the depth map, by executing instructions or program code of an object-of-interest module 520.

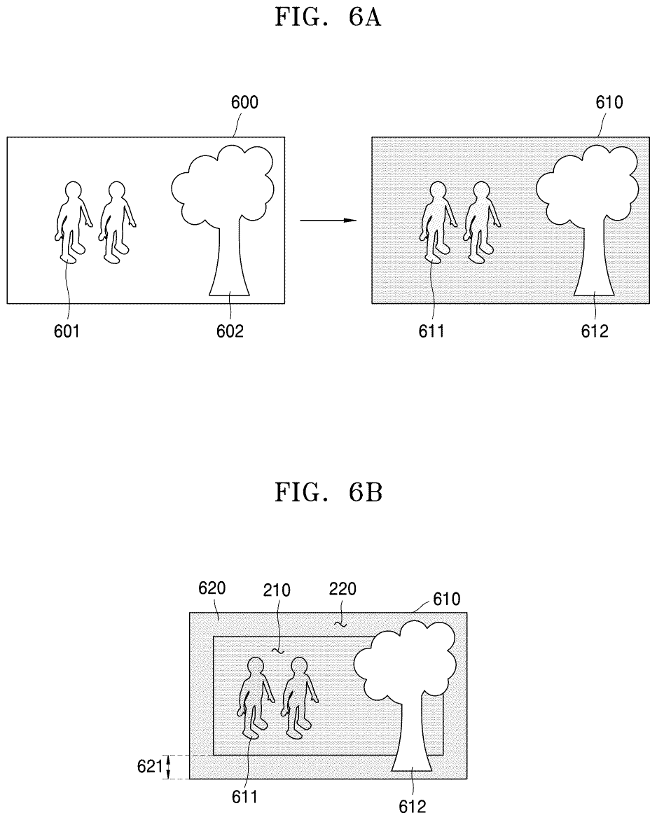

Examples of an operation of the electronic device 100 in the operation S130 S140 described below with reference to FIGS. 6A through 8.

According to an embodiment of the disclosure, the operation method of the electronic device 100 may include an operation S150 of calculating a reduction ratio for lowering the input resolution of the input image, based on the object of interest.

According to an embodiment of the disclosure, the input image may be an image having an input resolution. The first area 210 may be an area having a first resolution. The first area 210 having the first resolution may refer to the first area 210 being an area on which an image having the first resolution may be displayed.

According to an embodiment of the disclosure, the input resolution may greater than the first resolution. The input resolution may be a resolution corresponding to the first area 210 and the second area 220. The first resolution may be a resolution corresponding to the first area 210.

In the operation S150, the electronic device 100 may calculate the reduction ratio for lowering the input resolution of the input image, based on the object of interest.

According to an embodiment of the disclosure, the at least one processor 130 may calculate the reduction ratio for lowering the input resolution of the input image, based on the object of interest, by executing the instructions or program code of the corrected image generation module 122.

According to an embodiment of the disclosure, the corrected image generation module 122 may include an image reduction determination module 530. The image reduction determination module 530 may include instructions or program code related to an operation or function of obtaining the reduction ratio for lowering the input resolution of the input image, based on the object of interest.

The at least one processor 130 may calculate the reduction ratio for lowering the input resolution of the input image, based on the object of interest, by executing the instructions or program code of the image reduction determination module 530.

Examples of an operation of the electronic device 100 in the operation S150 the input image are described below with reference to FIG. 8.

According to an embodiment of the disclosure, the operation method of the electronic device 100 may include an operation S210 of generating the masking map, based on the reduction ratio, the frame image, and the object of interest.

According to an embodiment of the disclosure, in the operation S210, the electronic device 100 may generate the masking map, based on the reduction ratio, the frame image, and the object of interest.

According to an embodiment of the disclosure, the at least one processor 130 may generate the masking map, based on the reduction ratio, the frame image, and the object of interest, by executing the instructions or program code of the corrected image generation module 122.

According to an embodiment of the disclosure, the corrected image generation module 122 may include a masking map generation module 540. The masking map generation module 540 may include instructions or program code related to an operation or function of generating the masking map, based on the reduction ratio, the frame image, and the object of interest.

The at least one processor 130 may generate the masking map, based on the reduction ratio, the frame image, and the object of interest, by executing the instructions or program code of the masking map generation module 540.

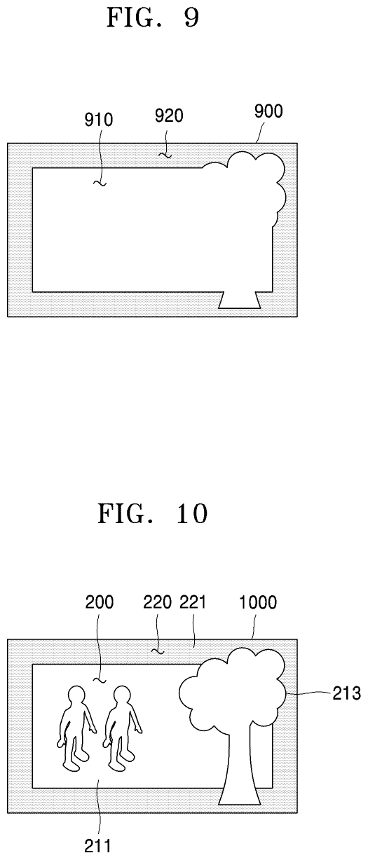

Examples of an operation of the electronic device 100 in the operation S210 of generating the masking map, based on the reduction ratio, the frame image, and the object of interest are described below with reference to FIG. 9.

According to an embodiment of the disclosure, the operation method of the electronic device 100 may include the operation S300, which may be performed based on the masking map generated based on the reduction ratio, the frame image, and the object of interest.

According to an embodiment of the disclosure, the at least one processor 130 may generate the corrected image by adding the input image and the frame image, based on the masking map generated based on the reduction ratio, the frame image, and the object of interest, by executing the instructions or program code of the corrected image generation module 122.

According to an embodiment of the disclosure, the corrected image generation module 122 may include an image generation module 560. The image generation module 560 may include instructions or program code related to an operation or function of generating the corrected image by adding the input image and the frame image, based on the masking map.

The at least one processor 130 may generate the corrected image by adding the input image and the frame image, based on the masking map, by executing the instructions or program code of the image generation module 560.

Examples of an operation of the electronic device 100 in the operation S300 of generating the corrected image by adding the input image and the frame image, based on the masking map, are described below with reference to FIG. 10.

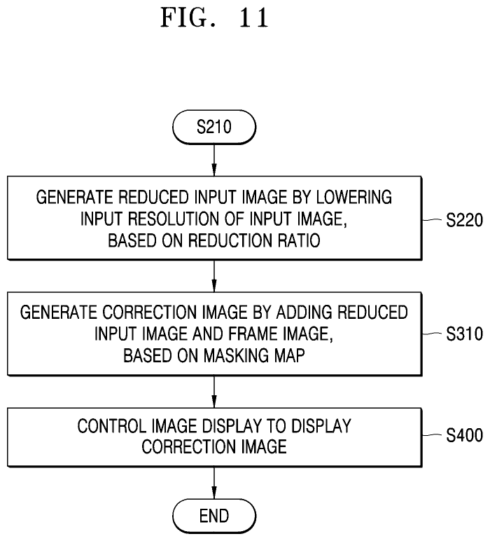

According to an embodiment of the disclosure, the operation method of the electronic device 100 may include an operation S220 (as shown for example in FIG. 11) of generating a reduced input image by lowering the input resolution of the input image, based on the reduction ratio.

According to an embodiment of the disclosure, the resolution of the reduced input image may be equal to or greater than the first resolution of the first area 210.

According to an embodiment of the disclosure, in the operation S220, the electronic device 100 may generate the reduced input image by lowering the input resolution of the input image, based on the reduction ratio.

According to an embodiment of the disclosure, the at least one processor 130 may generate the reduced input image by lowering the input resolution of the input image, based on the reduction ratio, by executing the instructions or program code of the corrected image generation module 122.

According to an embodiment of the disclosure, the corrected image generation module 122 may include an image reduction module 550. The image reduction module 550 may include instructions or program code related to an operation or function of generating the reduced input image by lowering the input resolution of the input image, based on the reduction ratio.

The at least one processor 130 may generate the reduced input image by lowering the input resolution of the input image, based on the reduction ratio, by executing the instructions or program code of the image reduction module 550.

According to an embodiment of the disclosure, because the reduced input image may be generated by lowering the input resolution of the input image, in the operation S300, the corrected image may be generated by adding the reduced input image and the frame image, based on the masking map.

Examples of an operation of the electronic device 100 in the operation S210 and the operation S300 are described below with reference to FIGS. 8, 10, and 11.

However, embodiments are not limited thereto. At least one of the plurality of operations S100 through S300 included in the operation method of the electronic device 100 illustrated in FIG. 4 may be omitted, or at least one operation may be added to the operations S100 through S300. Two or more of the plurality of operations S100 through S300 may be performed in parallel to each other. The plurality of operations S100 through S300 may be performed in a different order than the order shown in FIG. 4.

FIG. 6A is a view for explaining a saliency map according to an embodiment of the disclosure. FIG. 6B is a view for describing an operation of extracting an object-of-interest candidate, according to an embodiment of the disclosure.

Referring to FIG. 6A, according to an embodiment of the disclosure, an input image 600, and a saliency map 610 generated based on the input image 600 are illustrated.

Referring to FIGS. 2, 5 and 6A, according to an embodiment of the disclosure, the input image 600 may include a first object 601 and a second object 602. However, embodiments are not limited thereto, and the input image 600 may include at least one other object and a background image.

According to an embodiment of the disclosure, the at least one processor 130 may obtain the saliency map 610 including saliency information associated with the input image 600, by executing the instructions or program code of the saliency map module 510.

According to an embodiment of the disclosure, the saliency map 610 may include a first saliency value 611 of a first object and a second saliency value 612 of a second object. However, embodiments are not limited thereto, and, because the input image 600 further includes a background image and other objects, the saliency map 610 may also further include saliency information associated with the background image and the other objects.

According to an embodiment of the disclosure, an object that is determined to have a high user interest, or determined to have a high importance in the input image 600 may have a large saliency value.

FIG. 6A illustrates an example in which, in the saliency map 610, an object with a large saliency value is brighter than an object with a small saliency value. However, this is an example for convenience of explanation, and thus embodiments are not limited thereto. According to an embodiment of the disclosure, the saliency map 610 may be generated so that the input image 600 is divided into an object having a greater saliency value than a predetermined reference value and an object having a saliency value equal to or less than the predetermined reference value.

According to an embodiment of the disclosure, the second saliency value 612 may be greater than the first saliency value 611. The second object 602 may be an object that is determined to have a higher level of user interest than the first object 601. The second object 602 may be an object that is determined to have a higher level of interest than the first object 601.

According to an embodiment of the disclosure, the at least one processor 130 may extract an object having a saliency vale that is larger than a predetermined first value from the input image 600, based on the saliency map 610. The predetermined first value may be a value that is pre-set or predetermined because it is judged to be of high enough user interest or to be of high enough importance within the input image 600 to be displayed on the second area 220 of FIG. 6B and provided to the user.

According to an embodiment of the disclosure, based on determining that that the second saliency value 612 is greater than the predetermined first value, the at least one processor 130 may extract the second object 602 from the input image 600.

Referring to FIG. 6B, according to an embodiment of the disclosure, the saliency map 610 and a frame image 620 are illustrated. According to an embodiment of the disclosure, for convenience of explanation, the frame image 620 may be overlappingly displayed on the saliency map 610 (e.g., displayed as overlapping the saliency map 610).

According to an embodiment of the disclosure, an area on which the frame image 620 is displayed may be the second area 220. The frame image 620 may be displayed around the first area 210. In the example shown in FIG. 6B, the frame image 620 is illustrated as an image surrounding the first area 210. However, embodiments are not limited thereto. According to an embodiment of the disclosure, the frame image 620 may not surround the first area 210. According to an embodiment of the disclosure, the frame image 620 may be displayed on only some areas among areas which are adjacent to the first area 210, and may be not displayed on the remaining areas.

According to an embodiment of the disclosure, the frame image 620 may have a frame width 621. A width of the second area 220 may also be determined by the frame width 621. FIG. 6B shown an example in which, according to an embodiment of the disclosure, a width of the frame image 620 (e.g., the frame width 621) is illustrated as being constant. However, embodiments are not limited thereto. The frame image 620 may have different frame widths according to location.

In the example shown in FIG. 6B, the frame image 620 is illustrated as including only an image corresponding to the second area 220. However, embodiments are not limited thereto. The frame image 620 may have images respectively corresponding to the first area 210 and the second area 220. The image corresponding to the first area 210 among the frame image 620 may be masked by a masking map 900 (as shown for example in FIG. 9) as described below. An image of an area of the frame image 620 that is not masked by the masking map 900 may be provided to the user together with the input image 600.

Referring to FIGS. 6A and 6B, according to an embodiment of the disclosure, the at least one processor 130 may extract, as the object-of-interest candidate, an object which has a salience value that is greater than the predetermined first value and which corresponds to the second area 220, from among at least one object included in the input image 600.

According to an embodiment of the disclosure, the at least one processor 130 may extract the second object 602 as the object-of-interest candidate, based on determining that the second object 602 corresponds to the second area 220 on which the frame image 620 is displayed.

According to an embodiment of the disclosure, the at least one processor 130 may extract the second object 602 from the input image 600, as the object-of-interest candidate, based on the frame image 620 and the saliency map 610, by executing the instructions or program code of the object-of-interest module 520 of FIG. 5.

According to an embodiment of the disclosure, the at least one processor 130 may not extract the second object 602 as the object-of-interest candidate, based on determining that the second saliency value 612 is equal to or less than the predetermined first value. In this case, an object to be extracted as the object-of-interest candidate may not exist in the input image 600.

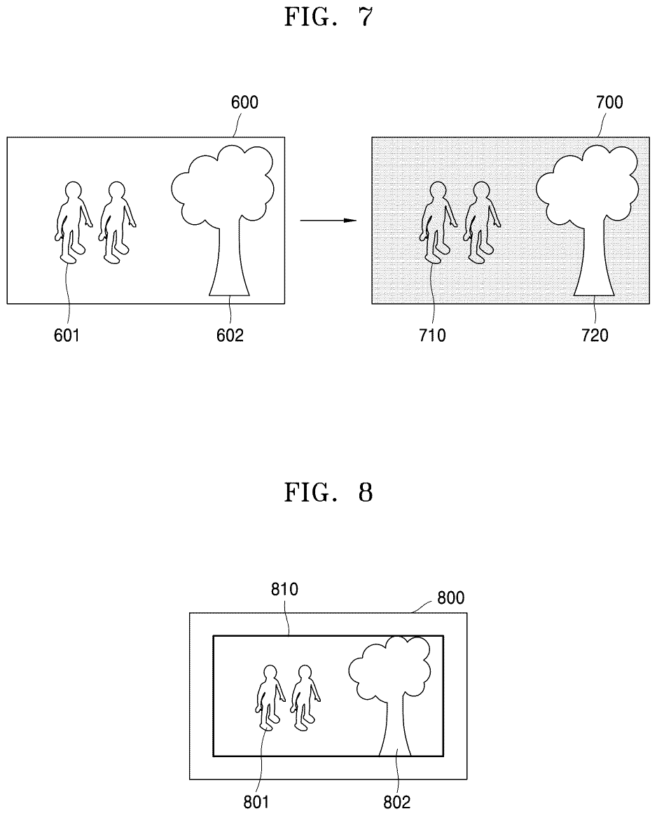

FIG. 7 is a view for explaining a depth map according to an embodiment of the disclosure.

Referring to FIG. 7, according to an embodiment of the disclosure, the input image 600, and a depth map 700 generated based on the input image 600 are illustrated.

Referring to FIGS. 2, 5, 6A, and 7, according to an embodiment of the disclosure, the input image 600 may include the first object 601 and the second object 602.

According to an embodiment of the disclosure, the at least one processor 130 may obtain the depth map 700 including depth information associated with the input image 600, by executing the instructions or program code of the depth map module 500.

According to an embodiment of the disclosure, the depth map 700 may include a first depth value 710 of a first object and a second depth value 720 of a second object. However, embodiments are not limited thereto, and, as the input image 600 further includes a background image and other objects, the depth map 700 may also further include depth information associated with the background image and the other objects.

According to an embodiment of the disclosure, as a distance of an object included in the input image 600 from a reference point of view increases, the object may have a smaller depth value. According to an embodiment of the disclosure, the reference point of view may be a location of a camera that has obtained an input image. However, embodiments are not limited thereto, and the reference point of view may be a location arbitrarily set as a reference point for generating an input image.

FIG. 7 illustrates an example the depth map 700 in which an object having a large depth value is brighter than an object having a small depth value. However, this is an example for convenience of explanation, and thus embodiments are not limited thereto.

According to an embodiment of the disclosure, a second depth value 720 may be greater than a first depth value 710. A distance between the second object 602 and the reference point of view may be less than a distance between the first object 601 and the reference point of view. A user may feel that the second object 602 is closer than the first object 601.

According to an embodiment of the disclosure, the at least one processor 130 may extract an object having a depth value that is larger than a predetermined second value from the input image 600, based on the depth map 700. The “predetermined second value” may be a value that is preset or predetermined because it is judged to be close enough to the user that the user does not feel a sense of incongruity even when an image having a corresponding depth value is displayed on the second area 220 of FIG. 6 and provided to the user.

According to an embodiment of the disclosure, based on determining that the second depth value 720 is greater than the predetermined second value, the at least one processor 130 may extract the second object 602 from the input image 600.

Referring to FIGS. 6B and 7, according to an embodiment of the disclosure, the at least one processor 130 may compare a depth value of the object-of-interest candidate extracted based on the saliency map 610 and the frame image 620 with a predetermined second depth value, based on the depth map 700. The at least one processor 130 may extract the object-of-interest candidate as the object of interest, based on determining that the depth value of the object-of-interest candidate is greater than the predetermined second depth value. Extracting an object-of-interest candidate as the object of interest may refer to defining or selecting the object-of-interest candidate as the object of interest.

According to an embodiment of the disclosure, the at least one processor 130 may extract the object-of-interest candidate as the object of interest, based on the depth map 700, by executing the instructions or program code of the object-of-interest module 520 of FIG. 5.

According to an embodiment of the disclosure, the at least one processor 130 may extract, as the object of interest, an object corresponding to the second area 220 from among at least one object included in the input image 600 and having depth information that does not give a sense of incongruity to the user.

Accordingly, even when the object of interest is displayed together with the frame image 620 as the second image 221 of FIG. 1 on the second area 220 and is provided to the user, the user may view or otherwise receive the image 200 with a natural stereoscopic effect from the electronic device 100.

According to an embodiment of the disclosure, when the depth value of the object-of-interest candidate is equal to or less than the predetermined second depth value, the at least one processor 130 may not extract the object-of-interest candidate as the object of interest. In this case, an object to be extracted as the object of interest may not exist in the input image 600.

FIG. 8 is a view for explaining a reduction ratio and a reduced input image according to an embodiment of the disclosure.

Referring to FIG. 8, according to an embodiment of the disclosure, an input image 800 having an input resolution and a reduced input image 810 having a resolution reduced based on the reduction ratio are illustrated.

Referring to FIGS. 2, 5, 6B, and 8, according to an embodiment of the disclosure, the input image 800 may include a first object 801 and a second object 802. The second object 802 may be an object extracted as an object of interest. For convenience of explanation, the second object may be referred to as an object of interest.

According to an embodiment of the disclosure, the at least one processor 130 may calculate a reduction ratio for lowering the input resolution of the input image 800, based on the saliency map 610, the frame image 620, and the depth map 700, by executing the instructions or program code of the image reduction determination module 530.

According to an embodiment of the disclosure, the at least one processor 130 may calculate the reduction ratio for lowering the input resolution of the input image 800, based on the object of interest (e.g., the second object 802) extracted from the input image 800.

According to an embodiment of the disclosure, the at least one processor 130 may calculate a distribution of the object of interest (e.g., the second object 802) included in the input image 800. The at least one processor 130 may calculate the distribution of the object of interest (e.g., the second object 802) within the input image 800 using a module including an algorithm for calculating a spatial distribution.

According to an embodiment of the disclosure, the at least one processor 130 may calculate a histogram of the input image 800 and a histogram of the object of interest (e.g., the second object 802). The at least one processor 130 may use the histogram of the input image 800 and the histogram of the object of interest (e.g., the second object 802) to determine whether the object of interest (e.g., the second object 802) is distributed throughout the input image 800 or densely distributed on a specific area.

However, embodiments are not limited thereto, and the at least one processor 130 may calculate the distribution of the object of interest (e.g., the second object 802) using various algorithms capable of calculating the distribution of the object of interest (e.g., the second object 802) within the input image 800.

The at least one processor 130 may determine whether the object of interest (e.g., the second object 802) is distributed widely or densely on the input image 800, through the distribution of the object of interest (e.g., the second object 802) within the input image 800.

According to an embodiment of the disclosure, the at least one processor 130 may calculate a distribution of the object of interest (e.g., the second object 802) in the second area 220. The at least one processor 130 may determine whether the object of interest (e.g., the second object 802) is distributed throughout the second area 220 or densely distributed on a specific area, using the calculated distribution of the object of interest (e.g., the second object 802) within the second area 220.

According to an embodiment of the disclosure, a calculated value including distribution information associated with the object of interest (e.g., the second object 802) may have a larger value as a degree to which the object of interest (e.g., the second object 802) is distributed throughout the second area 220 increases. The calculated value including distribution information associated with the object of interest (e.g., the second object 802) may have a smaller value as a degree to which the object of interest (e.g., the second object 802) is densely distributed on a specific area among the second area 220 increases.

According to an embodiment of the disclosure, the at least one processor 130 may calculate the reduction ratio for lowering the input resolution of the input image 800, according to the size of the calculated value including the distribution information associated with the object of interest (e.g., the second object 802). The reduction ratio may be a real number of one (“1”) or greater.

According to an embodiment of the disclosure, the at least one processor 130 may determine the reduction ratio so that the input resolution of the input image 800 is maintained, based on determining that the calculated value is less than a pre-determined distribution reference value. According to an embodiment of the disclosure, when the reduction ratio is one (“1”), this may mean that the input resolution of the input image 800 is maintained. However, embodiments are not limited thereto, and the at least one processor 130 may determine that the input image 800 is not reduced, based on determining that the calculated value is less than the pre-determined distribution reference value.

FIG. 8 illustrates that an example in which the reduced input image 810 has a lower resolution than the input image 800 due to reduction. However, embodiments are not limited thereto. According to an embodiment of the disclosure, because the reduction ratio is determined such that the input resolution of the input image 800 is maintained, the resolution of the reduced input image 810 may be the same as the input resolution of the input image 800.

According to an embodiment of the disclosure, based on determining that the calculated value is equal to or greater than the pre-determined distribution reference value, the at least one processor 130 may determine the reduction ratio so that the input resolution of the input image 800 decreases. According to an embodiment of the disclosure, when the reduction ratio is greater than one (“1”), the input resolution of the input image 800 may decrease.

According to an embodiment of the disclosure, because the reduction ratio is determined such that the input resolution of the input image 800 decreases, the resolution of the reduced input image 810 may be less than the input resolution of the input image 800. According to an embodiment of the disclosure, the reduced input image 810 having a smaller resolution than the input image 800 may be an image reduced to correspond to a smaller area than the input image 800.

According to an embodiment of the disclosure, reducing the input image 800 may refer to lowering the input resolution of the input image 800 so that the area of the input image 800 corresponds to a relatively small area.

According to an embodiment of the disclosure, based on determining that the calculated value is equal to or greater than the pre-determined distribution reference value, the at least one processor 130 may calculate a reduction ratio for reducing the input image 800 so that the object of interest (e.g., the second object 802) corresponding to the second area 220 corresponds to the first area 210.

In this case, the at least one processor 130 may calculate a reduction ratio so that the object of interest (e.g., the second object 802) included in the reduced input image 810 is displayed on the first area 210 rather than the second area 220. Referring to FIG. 8, the at least one processor 130 may calculate the reduction ratio so that the input image 800 is reduced and thus the object of interest (e.g., the second object 802) is displayed on the first area 210. The reduction ratio may be calculated based on, for example, a location of the object of interest (e.g., the second object 802) on the second area 220 and a size of the object of interest (e.g., the second object 802).

According to an embodiment of the disclosure, when an object extracted as an object of interest is not included in the input image 800, the at least one processor 130 may calculate the reduction ratio for lowering the input resolution of the input image 800.

According to an embodiment of the disclosure, the at least one processor 130 may calculate the reduction ratio for lowering the input image 800 so that the input image 800 corresponding to the first area 210 and the second area 220 corresponds to the first area 210.

In this case, the reduction ratio may be determined by a ratio between the first area 210 and a sum of the first area 210 and the second area 220.

According to an embodiment of the disclosure, the reduced input image 810 reduced according to the calculated reduction ratio may correspond to the first area 210. The input image 800 corresponding to the first area 210 and the second area 220 may be reduced to correspond to the first area 210.

Accordingly, a reduced object of interest included in the reduced input image 810 may correspond to the first area 210. The reduced input image 810 may be displayed as the first image 211 on the first area 210, and the frame image 620 may be displayed as the second image 221 on the second area 220.

FIG. 9 is a view for explaining a masking map according to an embodiment of the disclosure. FIG. 10 is a view for explaining a corrected image including an input image in a first area and including an object of interest and a frame image in a second area, according to an embodiment of the disclosure.

Referring to FIG. 9, according to an embodiment of the disclosure, a masking map 900 may include a first masking area 910 and a second masking area 920.

Referring to FIGS. 2, 5, 6B, 8, and 9, according to an embodiment of the disclosure, the masking map 900 may be a map generated to mask each of the input image 600 and the frame image 620, when generating a corrected image 1000 based on the input image 600 and the frame image 620.

According to an embodiment of the disclosure, the at least one processor 130 may generate the masking map 900, based on the object of interest and the frame image 620.

According to an embodiment of the disclosure, the first masking area 910 may refer to an area corresponding to an object of interest in the first area 210 and the second area 220. The first masking area 910 may be an area for selecting components of the input image 600 and masking components of the frame image 620.

The second masking area 920 may be an area corresponding to the remaining area in the second area 220 excluding the area corresponding to the object of interest. The second masking area 920 may be an area for selecting the components of the frame image 620 and masking the components of the input image 600.

According to an embodiment of the disclosure, the masking map 900 may mask the remaining area in the second area 220 excluding the area corresponding to the object of interest from the input image 600. The input image 600 masked by the masking map 900 may be displayed on the area corresponding to the object of interest in the first area 210 and the second area 220.

According to an embodiment of the disclosure, the masking map 900 may mask the area corresponding to the object of interest in the first area 210 and the second area 220 among the frame image 620. The frame image 620 masked by the masking map 900 may be displayed on the remaining area excluding the area corresponding to the object of interest among the second area 220.

However, embodiments are not limited thereto, and the first masking area 910 and the second masking area 920 may vary according to whether the object of interest is included in the input image 600 and whether the object of interest reduced according to the reduction ratio of the input image 600 corresponds to the second area 220. According to an embodiment of the disclosure, the masking map 900 may be generated using the object of interest and the frame image 620 when the reduction ratio is one (“1”).

Referring to FIG. 10, according to an embodiment of the disclosure, a corrected image 1000 is illustrated on the first area 210. The corrected image 1000 may include the first image 211 displayed on the first area 210, and the second image 221 displayed on the second area 220.

Referring to FIGS. 2, 5, 9, and 10, according to an embodiment of the disclosure, the at least one processor 130 may generate the corrected image 1000 by adding an input image 600 of FIG. 6A and the frame image 620 of FIG. 6B, based on the masking map 900.

At this time, the corrected image 1000 may be generated by adding an input image and a frame image each masked by the masking map 900. According to an embodiment of the disclosure, the masking map 900 may include different masking coefficients in the first masking area 910 and the second masking area 920, respectively. The at least one processor 130 may generate the corrected image 1000 using the input image 600, the frame image 620, and the masking map 900 having different masking coefficients in the first masking area 910 and the second masking area 920,.

According to an embodiment of the disclosure, the first image 211 may include at least a portion of the input image 600 corresponding to the first area 210. The first image 211 may include a portion of the object of interest (e.g., the second object 213) corresponding to the first area 210.

According to an embodiment of the disclosure, the second image 221 may include at least a portion of the object of interest (e.g., the second object 213) corresponding to the second area 220. The second image 221 may include an image corresponding to the remaining area in the second area 220 excluding the area corresponding to the object of interest (e.g., the second object 213) among the frame image 620.

According to an embodiment of the disclosure, the at least one processor 130 may control the image display 110 to display the corrected image 1000. The electronic device 100 may provide the corrected image 1000 to the user through the image display 110.

According to an embodiment of the disclosure, when a user using the electronic device 100 is provided with the corrected image 1000 including the first image 211 in the first area 210 and the second image 221 in the second area 220, a high sense of immersion may be provided to the user. In addition, a different experience may be provided to the user by providing frame images 620 of various types (e.g., a theater background, a picture frame, a window, audience, an animal, and a landscape) together with the input image 600.

Moreover, when the object of interest (e.g., the second object 213) in addition to the frame image 620 is displayed on the second area 220, the user may be provided with a stereoscopic effect, as if the object of interest (e.g., the second object 213) is located in front of the first image 211. Accordingly, a stereoscopic image may be provided to the user.

However, embodiments are not limited thereto, and the masking map 900 may include a third masking area. The third masking area may be an area located between the first masking area 910 and the second masking area 920. The third masking area may be an area that masks some of the components of the input image 600 and some of the components of the frame image 620. The third masking area may be an area allowing the remaining components of the input image and the remaining components of the frame image 620 to be displayed together. Accordingly, the input image 600 and the frame image 620 included in the corrected image 1000 may be naturally provided to the user.

However, embodiments are not limited thereto, and the at least one processor 130 may generate the masking map 900, based on the reduction ratio, the frame image 620, and the object of interest.

Referring again to FIGS. 2, 5, 6B, and 9, according to an embodiment of the disclosure, the reduction ratio may be calculated so that the input resolution of the input image 800 may be lowered, according to the size of the calculated value including a distribution degree of the object of interest (e.g., the second object 802). According to the reduction ratio, an object of interest included in the input image 600 may be reduced to correspond to the first area 210.

In this case, the first masking area 910 included in the masking map 900 may be an area corresponding to the first area 210. The second masking area 920 may be an area corresponding to the second area 220.

According to an embodiment of the disclosure, the masking map 900 may mask the area of the input image 600 corresponding to the second area 220. The input image 600 masked by the masking map 900 may be displayed on the first area 210.

According to an embodiment of the disclosure, the masking map 900 may mask the area corresponding to the first area 210 among the frame image 620. The frame image 620 masked by the masking map 900 may be displayed on the second area 220.

According to an embodiment of the disclosure, when a user using the electronic device 100 is provided with the corrected image 1000 including the first image 211 in the first area 210 and the second image 221 in the second area 220, a high sense of immersion may be provided to the user.

FIG. 11 is a flowchart of an operation of generating a corrected image by adding a reduced input image and a frame image, based on a masking map, according to an embodiment of the disclosure. Operations that are the same as those described above with reference to FIG. 4 are given the same reference numerals, and thus redundant descriptions thereof will be omitted.

Referring to FIGS. 2, 4, 5, 8, and 11, according to an embodiment of the disclosure, the operation method of the electronic device 100 may include an operation S220 of generating the reduced input image by lowering the input resolution of the input image, based on the calculated reduction ratio.

According to an embodiment of the disclosure, the operation S220 may be performed after the operation S210. However, embodiments are not limited thereto, and the operation S220 may be performed after the operation S150.

According to an embodiment of the disclosure, in the operation S220, the at least one processor 130 may generate the reduced input image by lowering the input resolution of the input image, based on the reduction ratio.

According to an embodiment of the disclosure, the operation method of the electronic device 100 may include an operation S310 of generating the corrected image by adding the reduced input image and the frame image, based on the masking map. The masking map used at this time may be a masking map generated based on the reduction ratio, the frame image 620, and the object of interest.

According to an embodiment of the disclosure, in the operation S310, the at least one processor 130 may generate the corrected image by adding the reduced input image and the frame image, based on the masking map.

According to an embodiment of the disclosure, the operation method of the electronic device 100 may include an operation S400 of controlling the image display 110 to display the corrected image. The electronic device 100 may display the corrected image through the image display 110.

According to an embodiment of the disclosure, the corrected image displayed in the operation S400 may be an image in which the reduced input image is displayed on the first area 210 and the frame image is displayed on the second area 220.

According to an embodiment of the disclosure, the at least one processor 130 may control the image display 110 to display the corrected image.

According to an embodiment of the disclosure, the input image 600 may include a plurality of sub-input images respectively corresponding to a plurality of frames. The input image 600 may be a video including a plurality of sub-input images.

According to an embodiment of the disclosure, the at least one processor 130 may extract the object of interest by performing the operation of FIGS. 6A through 8 with respect to each of the plurality of sub-input images, and may calculate the reduction ratio of each of the plurality of sub-input images.

According to an embodiment of the disclosure, the at least one processor 130 may generate masking maps respectively corresponding to the plurality of sub-input images by performing the operation of FIGS. 9 through 11, based on respective reduction ratios of the plurality of sub-input images. The at least one processor 130 may generate a plurality of corrected images respectively corresponding to the plurality of frames using the masking maps.

According to an embodiment of the disclosure, the at least one processor 130 may display the plurality of corrected images through the image display 110 to provide the plurality of corrected images to the user. Accordingly, the electronic device 100 may provide an immersive image or a stereoscopic image to the user by considering inclusion or non-inclusion of an object of interest and the distribution of the object of interest during the plurality of frames.

Effects obtainable from the disclosure are not limited to the aforementioned technical effects, and other effects not mentioned will be clearly understood by a person skilled in the art to which the disclosure pertains from the following description.

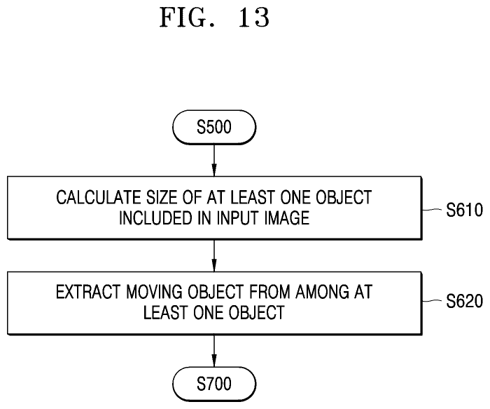

FIG. 12 is a flowchart of an operation of generating a movement corrected image including a moving object, according to an embodiment of the disclosure. FIG. 13 is a flowchart of an operation of extracting a moving object according to the size of an object included in an input image, according to an embodiment of the disclosure. Operations that are the same as those described above with reference to FIG. 3 are given the same reference numerals, and thus redundant descriptions thereof will be omitted.

Referring to FIGS. 2, 3, and 12, according to an embodiment of the disclosure, an operation method of the electronic device 100 may include an operation S500 of obtaining motion information by estimating a movement of the input image 600 of FIG. 6, based on the input image 600.

According to an embodiment of the disclosure, the operation S500 may be performed after the operation S100 of obtaining the input image 600 and the frame image 620.

According to an embodiment of the disclosure, the motion information may refer to information about a movement of at least one object included in the input image 600. According to an embodiment of the disclosure, when the input image 600 includes the plurality of sub-input images respectively corresponding to the plurality of frames, the motion information may include information about a direction in which and a distance by which the at least one object included in the input image 600 moves during the plurality of frames.

According to an embodiment of the disclosure, the motion information may include an optical flow. According to an embodiment of the disclosure, the optical flow may be a vector component including information about a direction in which and a distance by which an object moves during the plurality of frames.

According to an embodiment of the disclosure, the direction of the optical flow may correspond to the direction in which an object included in the input image 600 moves during the plurality of frames. According to an embodiment of the disclosure, the size of the optical flow may correspond to the size of the distance by which the object included in the input image 600 moves during the plurality of frames. According to an embodiment of the disclosure, the optical flow may be estimated based on two sub-input images corresponding to two adjacent frames.

According to an embodiment of the disclosure, the motion information may include the speed of the at least one object included in the input image 600.

According to an embodiment of the disclosure, in the operation S500, the electronic device 100 may obtain the motion information by estimating the movement of the input image 600.

According to an embodiment of the disclosure, the at least one processor 130 may obtain the motion information by estimating the movement of the input image 600, by executing the instructions or program code of the movement corrected image generation module 123.

According to an embodiment of the disclosure, the operation method of the electronic device 100 may include an operation S600 of extracting a moving object from the input image 600, based on the motion information.

According to an embodiment of the disclosure, in the operation S600, the electronic device 100 may extract the moving object from the input image 600, based on the motion information.

According to an embodiment of the disclosure, the at least one processor 130 may extract the moving object from the input image 600, based on the motion information, by executing the instructions or program code of the movement corrected image generation module 123.

Referring to FIGS. 12 and 13, according to an embodiment of the disclosure, the operation S600 may include an operation S610 of calculating the size of the at least one object included in the input image 600. In the operation S610, the electronic device 100 may detect the at least one object included in the input image 600 and calculate the size of the detected object.

According to an embodiment of the disclosure, in the operation S610, the electronic device 100 may calculate the size of the at least one object included in the input image 600. The electronic device 100 may detect the at least one object included in the input image 600 and calculate the size of the detected object.

According to an embodiment of the disclosure, the at least one processor 130 may calculate the size of the at least one object included in the input image 600, by executing the instructions or program code of the movement corrected image generation module 123. The at least one processor 130 may detect the at least one object included in the input image 600 and calculate the size of the detected object, by executing the instructions or program code of the movement corrected image generation module 123.

According to an embodiment of the disclosure, the moving object may refer to an object having a size that is smaller than a predetermined third value among the at least one object included in the input image 600. According to an embodiment of the disclosure, the moving object may refer to an object having a size that is smaller than the predetermined third value among the at least one object included in the input image 600 of which a location moves over the plurality of frames.

According to an embodiment of the disclosure, when an object that is too large among the at least one object included in the input image 600 is extracted as the moving object, and the moving object to be described later is displayed on the second area 220, an awkward experience may be rather provided to the user. Accordingly, the third value may be a predetermined size that enables the user not to feel a sense of incongruity even when the moving object is displayed on the second area 220. According to an embodiment of the disclosure, the third value may be set to have 1/10 times the size of the first area 210. However, embodiments are not limited thereto.

According to an embodiment of the disclosure, the operation S600 of extracting the moving object from the input image 600, based on the motion information, may include an operation S620 of extracting an object having a size that is smaller than the predetermined third value, as the moving object, from among the at least one object included in the input image 600, based on the motion information and the size of the object.

According to an embodiment of the disclosure, in the operation S600, the electronic device 100 may extract the object having the smaller size than the predetermined third value, as the moving object, from among the at least one object included in the input image 600, based on the motion information and the size of the object.

According to an embodiment of the disclosure, the moving object may refer to an object having a size that is smaller than the predetermined third value and having a location moving over the plurality of frames among the input image 600.

According to an embodiment of the disclosure, the at least one processor 130 may extract the object having the size that is smaller than the predetermined third value and having a location changing over the plurality of frames according to the motion information, as the moving object, from among the at least one object included in the input image 600, based on the motion information and the size of the object, by executing the instructions or program code of the movement corrected image generation module 123.

According to an embodiment of the disclosure, in the operation S600, the electronic device 100 may extract the moving object from among the at least one object included in the input image 600, using the depth map 700 of FIG. 7 including the depth information associated with the input image 600.

According to an embodiment of the disclosure, the electronic device 100 may extract, as the moving object, an object having a size that is smaller than the predetermined third value, having a location changing over the plurality of frames, and having a greater depth value than the predetermined second value, from among the at least one object included in the input image 600.

Referring again to FIG. 12, according to an embodiment of the disclosure, the operation method of the electronic device 100 may include an operation S700 of calculating an expected location of the moving object on a next frame.

According to an embodiment of the disclosure, the moving object extracted in operation S600 may be an object included in the input image 600 on a current frame. The moving object extracted in operation S600 may include location information on the current frame.

According to an embodiment of the disclosure, in the operation S700, the expected location of the moving object on the next frame may be calculated using the velocity of the moving object on the current frame included in the motion information and the location information associated with the moving object on the current frame.

According to an embodiment of the disclosure, in the operation S700, the electronic device 100 may calculate the expected location of the moving object on the next frame.

According to an embodiment of the disclosure, the at least one processor 130 may calculate the expected location of the moving object on the next frame by executing the instructions or program code of the movement corrected image generation module 123. The at least one processor 130 may calculate the expected location of the moving object on the next frame using the velocity of the moving object on the current frame included in the motion information and the location information associated with the moving object on the current frame.

According to an embodiment of the disclosure, the operation method of the electronic device 100 may include an operation S800 of determining whether the expected location on the next frame exists on the second area 220 of FIG. 1.

According to an embodiment of the disclosure, the electronic device 100 may determine whether the expected location on the next frame exists on the second area 220. The at least one processor 130 may determine whether the expected location on the next frame exists on the second area 220, by executing the instructions or program code of the movement corrected image generation module 123.

According to an embodiment of the disclosure, the operation method of the electronic device 100 may include an operation S900 of, based on determining that the expected location on the next frame exists on the second area 220 (YES at operation S800), generating a movement corrected image including the moving object positioned at the expected location on the second area 220 of the corrected image, based on the corrected image and the moving object.

According to an embodiment of the disclosure, the corrected image used in the operation S900 may refer to the corrected image 1000 of FIG. 10 generated according to the examples shown in FIGS. 3 through 11.

According to an embodiment of the disclosure, based on determining that the expected location on the next frame exists on the second area 220, the electronic device 100 may generate a movement corrected image including the moving object positioned at the expected location on the second area 220 of the corrected image, based on the corrected image and the moving object.

According to an embodiment of the disclosure, by executing the instructions or program code of the movement corrected image generation module 123, the at least one processor 130 may generate a movement corrected image including the moving object positioned at the expected location on the second area 220 of the corrected image, based on the corrected image and the moving object, based on determining the expected location on the next frame exists on the second area 220.

According to an embodiment of the disclosure, the operation method of the electronic device 100 may include an operation of controlling the image display 110 to display the generated movement corrected image. The electronic device 100 may control the image display 110 to display the generated movement corrected image. The at least one processor 130 may control the image display 110 to display the movement corrected image, by executing the instructions or program code of the image display module 124.

According to an embodiment of the disclosure, the movement corrected image may be an image displayed through the image display 110. The at least one processor 130 may control the image display 110 to display a movement corrected image on the next frame, by executing the instructions or program code of the image display module 124.

Accordingly, when a moving object not located on the second area 220 in the current frame is expected to be located on the second area 220 in the next frame, based on the motion information, etc., the electronic device 100 may display the movement corrected image to provide the same to the user.

According to an embodiment of the disclosure, the operating method of the electronic device 100 may include an operation of controlling the image display 110 to display the corrected image 1000 generated according to the examples shown in FIGS. 3 through 11, based on determining that the expected location in the next frame does not exist on the second area 220.

Based on determining that the expected location in the next frame does not exist on the second area 220 (NO at operation S800), the electronic device 100 may display the corrected image 1000 through the image display 110.

However, embodiments are not limited thereto. When the input image 600 includes the plurality of sub-input images over the plurality of frames, operations S500 through S800 may be performed for each frame. According to an embodiment of the disclosure, in the operation method of the electronic device 100, when it is determined in operation S800 that the expected location on the next frame does not exist on the second area 220 (NO at operation S800), operations S500 through S800 may be performed again on the next frame.

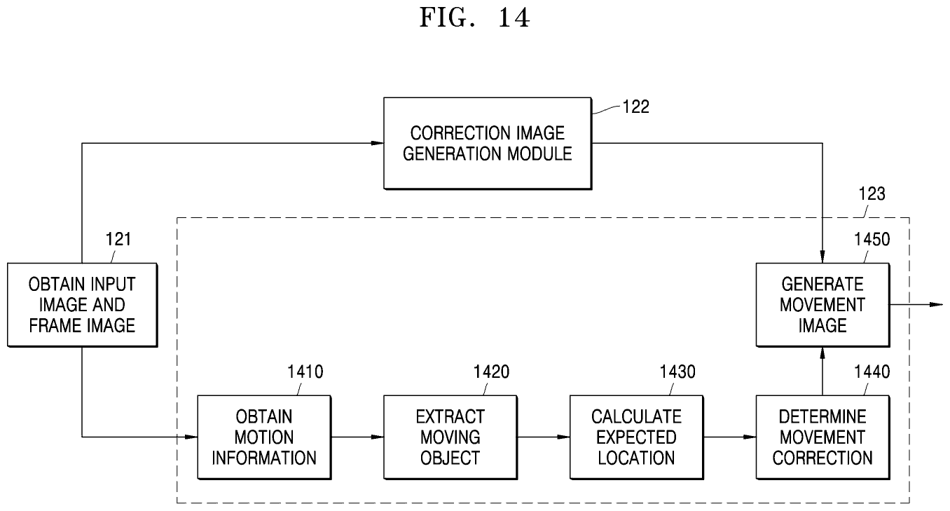

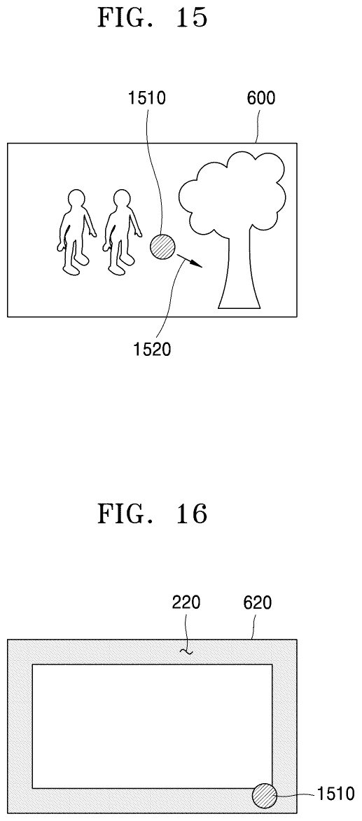

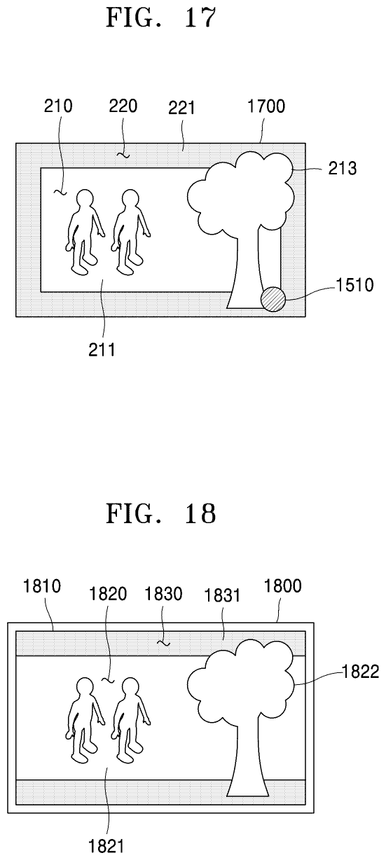

FIG. 14 is a block diagram for explaining an operation of generating a movement corrected image including a moving object, according to an embodiment of the disclosure. FIG. 15 is a view for explaining an operation of extracting a moving object from an input image, based on motion information associated with the input image, according to an embodiment of the disclosure. FIG. 16 is a view for explaining an operation of calculating an expected location of a moving object in a next frame, according to an embodiment of the disclosure. FIG. 17 is a view for explaining a movement corrected image including a moving object, according to an embodiment of the disclosure.

Components that are the same as those described above with reference to FIGS. 5 and 6B are given the same reference numerals, and thus redundant descriptions thereof will be omitted.

Referring to FIGS. 2, 12, and 14, according to an embodiment of the disclosure, the movement corrected image generation module 123 may include a motion information module 1410. The motion information module 1410 may include instructions or program code related to an operation or function of obtaining the motion information by estimating a movement of the input image 600.

According to an embodiment of the disclosure, the motion information module 1410 may include an AI model. According to an embodiment of the disclosure, the AI model included in the motion information module 1410 may include a machine learning or deep learning model. According to an embodiment of the disclosure, the AI model included in the motion information module 1410 may be an AI model trained to receive an image or a video as an input and infer motion information.

According to an embodiment of the disclosure, the at least one processor 130 may obtain the motion information, based on the input image 600, by executing the instructions or program code of the motion information module 1410.

According to an embodiment of the disclosure, the movement corrected image generation module 123 may include a moving object extraction module 1420. The moving object extraction module 1420 may include instructions or program code related to an operation or function of extracting the moving object from the input image 600, based on the motion information.

According to an embodiment of the disclosure, the moving object extraction module 1420 may include instructions or program code related to an operation or function of detecting the at least one object included in the input image 600 and calculating the size of the detected object.

According to an embodiment of the disclosure, the moving object extraction module 1420 may include instructions or program code related to an operation or function of extracting an object having a size that is smaller than the predetermined third value, as the moving object, from among the at least one object included in the input image 600, based on the motion information and the size of the object.

According to an embodiment of the disclosure, the moving object extraction module 1420 may include instructions or program code related to an operation or function of extracting an object having a size that is smaller than the predetermined third value and having a location moving over the plurality of frames, as the moving object, from among the at least one object included in the input image 600, based on the motion information and the size of the object.

Referring to FIG. 15, according to an embodiment of the disclosure, a moving object 1510 detected from the input image 600 is illustrated. In this case, the moving object 1510 may be an object having a size that is smaller than the predetermined third value. When the third value is set as the size of an area, the area of the moving object 1510 may be less than the third value. When the third value is set as the size of a diameter, the size of the diameter of the moving object 1510 may be less than the third value. However, embodiments are not limited thereto, and a size comparison between the moving object 1510 and the third value may be performed in various ways.

According to an embodiment of the disclosure, motion information 1520 of the moving object 1510 is illustrated in FIG. 15. The motion information 1520 may refer to velocity information in the current frame of the moving object 1510.

Referring to FIGS. 14 and 15, according to an embodiment of the disclosure, the at least one processor 130 may extract the moving object 1510 from the input image 600, based on the motion information, by executing the instructions or program code of the moving object extraction module 1420. The at least one processor 130 may extract the moving object 1510 from the input image 600, based on the motion information and the size of the object, by executing the instructions or program code of the moving object extraction module 1420.

Referring again to FIG. 14, according to an embodiment of the disclosure, the movement corrected image generation module 123 may include an expected location calculation module 1430. The expected location calculation module 1430 may include instructions or program code related to an operation or function of calculating the expected location of the moving object 1510 in the next frame, based on the motion information associated with the moving object.

According to an embodiment of the disclosure, the expected location calculation module 1430 may include instructions or program code related to an operation or function of calculating the expected location of the moving object 1510 in the next frame, based on location information associated with the moving object 1510 in the current frame and motion information associated with the moving object 1510 in the current frame.

FIG. 16 illustrates an example in which the frame image 620 is displayed on the second area 220 and the moving object 1510 is positioned at the expected location in the next frame.

Referring to FIGS. 14 and 16, according to an embodiment of the disclosure, the at least one processor 130 may calculate the expected location of the moving object 1510 in the next frame, based on the location information associated with the moving object 1510 in the current frame and the motion information associated with the moving object 1510 in the current frame, by executing the instructions or program code of the expected location calculation module 1430.

According to an embodiment of the disclosure, the at least one processor 130 may store the expected location of the moving object 1510 on the next frame by executing the instructions or program code of the expected location calculation module 1430. The at least one processor 130 may determine whether the expected location exists on the second area 220, and may use the expected location of the moving object 1510 in the next frame stored in the memory 120 to generate a movement corrected image 1700 of FIG. 17.

Referring again to FIG. 14, according to an embodiment of the disclosure, the movement corrected image generation module 123 may include a movement correction determination module 1440. The movement correction determination module 1440 may include instructions or program code related to an operation or function of determining whether the calculated expected location exists on the second area 220.

According to an embodiment of the disclosure, the movement correction determination module 1440 may include instructions or program code related to an operation or function of determining whether the calculated expected location exists on the second area 220, using location information associated with the calculated expected location and location information associated with the second area 220.

FIG. 16 illustrates an example in which the moving object 1510 positioned at the calculated expected location exists on the second area 220. The moving object 1510 positioned at the expected location may overlap the frame image 620 displayed on the second area 220.

Referring to FIGS. 14 and 16, according to an embodiment of the disclosure, the at least one processor 130 may determine whether the expected location exists on the second area 220, by executing the instructions or program code of the movement correction determination module 1440.

Referring again to FIG. 14, according to an embodiment of the disclosure, the movement corrected image generation module 123 may include a movement image generation module 1450. The movement image generation module 1450 may include instructions or program code related to an operation or function of generating the movement corrected image, based on the corrected image 1000 generated by the corrected image generation module 122 and the moving object 1510.

According to an embodiment of the disclosure, the movement image generation module 1450 may include instructions or program code related to an operation or function of obtaining a frame image for generating the movement corrected image by adding the corrected image 1000 to the moving object 1510 positioned at the expected location.

According to an embodiment of the disclosure, the movement image generation module 1450 may include instructions or program code related to an operation or function of obtaining a frame image for generating the movement corrected image by adding the corrected image 1000 to the moving object 1510 positioned at the expected location, when the movement correction determination module 1440 determines that the expected location exists on the second area 220.

Referring to FIGS. 10, 16, and 17, according to an embodiment of the disclosure, the movement corrected image 1700 is illustrated in FIG. 17. The movement corrected image 1700 may be an image including the corrected image 1000 illustrated in FIG. 10 and the moving object 1510 positioned at the calculated expected location.

According to an embodiment of the disclosure, the first image 211 may include at least a portion of the input image 600 corresponding to the first area 210. The first image 211 may include a portion of the object of interest (e.g., the second object 213) corresponding to the first area 210. The first image 211 may include a portion of the moving object 1510 positioned at the calculated expected location corresponding to the first area 210.

According to an embodiment of the disclosure, the second image 221 may include at least a portion of the object of interest (e.g., the second object 213) corresponding to the second area 220. The second image 221 may include an image corresponding to the remaining area in the second area 220 excluding the area corresponding to the object of interest (e.g., the second object 213) among the frame image 620. The second image 221 may include the moving object 1510 positioned at the calculated expected location corresponding to the second area 220.

Referring to FIGS. 14 and 17, according to an embodiment of the disclosure, by executing the instructions or program code of the movement image generation module 1450, the at least one processor 130 may generate the movement corrected image 1700 including the moving object positioned at the expected location on the second area 220 of the corrected image, based on the corrected image and the moving object, when the calculated expected location exists on the second area 220.

According to an embodiment of the disclosure, when the moving object 1510 moving during the plurality of frames in the input image 600 is located on the second area 220 in the next frame and is thus expected to be covered by the frame image 620, the movement corrected image 1700 may be provided to the user, thereby providing a stereoscopic effect to the user using the electronic device 100.

In addition, the user may be provided with a feeling that the moving object 1510 is moving out of the first area 210 or out of a display area, thereby improving the user's sense of immersion.

Effects obtainable from the disclosure are not limited to the aforementioned technical effects, and other effects not mentioned will be clearly understood by a person skilled in the art to which the disclosure pertains from the following description.

FIG. 18 is a view for explaining an operation of an electronic device 1800 according to an embodiment of the disclosure.

Referring to FIG. 18, according to an embodiment of the disclosure, the electronic device 1800 is shown as a device including a display 1810. According to an embodiment of the disclosure, the electronic device 1800 may have a shape, such as a television, a mobile device, a smartphone, or a laptop computer.

According to an embodiment of the disclosure, the electronic device 1800 illustrated in FIG. 18 may also include the plurality of components illustrated in FIG. 2. In addition, the electronic device 1800 illustrated in FIG. 18 may perform the operations illustrated in FIGS. 2 through 17.

According to an embodiment of the disclosure, the electronic device 1800 may display the corrected image 1000 (as shown for example in FIG. 10) or the movement corrected image 1700 of FIG. 17 using a display 1810. The at least one processor 130 of FIG. 2 may control the display 1810 to display the corrected image 1000 or the movement corrected image 1700. The display 1810 may correspond to the image display 110 of FIG. 2.

According to an embodiment of the disclosure, the display 1810 may include a display area. The display area may include a first area 1820 and a second area 1830. According to an embodiment of the disclosure, the second area 1830 may be located on an upper side and lower side of the first area 1820. The second area 1830 may be an area adjacent to the first area 1820. However, embodiments are not limited thereto, and the second area 1830 may be an area adjacent to the first area 1820 in only one direction, or may be an area adjacent to the first area 1820 in all directions.

According to an embodiment of the disclosure, a first image 1821 may be displayed on the first area 1820. A second image 1831 may be displayed on the second area 1830. The first image 1821 may include at least a portion of the input image 600 of FIG. 6A corresponding to the first area 1820. The first image 1821 may include a portion of the object of interest 1822 corresponding to the first area 1820.

According to an embodiment of the disclosure, the second image 1831 may include at least a portion of the object of interest 1822 corresponding to the second area 1830. The second image 1831 may include an image corresponding to the remaining area in the second area 1830 excluding the area corresponding to the object of interest 1822 among the frame image 620 of FIG. 6B.

However, embodiments are not limited thereto, and the electronic device 1800 may also provide a user with the movement corrected image 1700 further including the object of interest (e.g., the moving object 1510) of FIG. 17 by displaying the movement corrected image 1700 through the display 1810.

The program executed by the electronic device described above herein may be implemented as a hardware component, a software component, and/or a combination of hardware components and software components. The program may be executed by any system capable of executing computer readable instructions.

The software may include a computer program, a code, instructions, or a combination of one or more of the foregoing, and may constitute a processing device so that the processing device can operate as desired, or may independently or collectively instruction the processing device.

The software may be implemented as a computer program including instructions stored in computer-readable storage media. Examples of the computer-readable recording media include magnetic storage media (e.g., ROM, floppy disks, hard disks, etc.), and optical recording media (e.g., compact disc ROMs (CD-ROMs), or digital versatile discs (DVDs)). The computer-readable recording media can be distributed over network coupled computer systems so that the computer-readable code is stored and executed in a distributive manner. These recording media can be read by the computer, stored in memory, and executed by a processor.

A computer-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the non-transitory storage medium may include a buffer in which data is temporarily stored.

Programs according to various embodiments disclosed herein may be provided by being included in computer program products. The computer program product, which is a commodity, may be traded between sellers and buyers.

Computer program products may include a software program and a computer-readable storage medium having the software program stored thereon. For example, computer program products may include a product in the form of a software program (e.g., a downloadable application) that is electronically distributed through electronic device manufacturers or electronic markets (e.g., Samsung Galaxy Store). For electronic distribution, at least a portion of the software program may be stored on a storage medium or may be created temporarily. In this case, the storage medium may be a server of a manufacturer of an electronic device, a server of an electronic market, or a storage medium of a relay server for temporarily storing a software (SW) program.

While the disclosure has been particularly shown and described with reference to examples thereof, it will be understood by those of ordinary skill in the art that various changes in form and details may be made therein without departing from the spirit and scope of the disclosure as defined by the following claims. For example, an appropriate result may be attained even when the above-described techniques are performed in a different order from the above-described method, and/or components, such as the above-described computer system or module, are coupled or combined in a different form from the above-described methods or substituted for or replaced by other components or equivalents thereof.

Effects obtainable from the disclosure are not limited to the aforementioned technical effects, and other effects not mentioned will be clearly understood by a person skilled in the art to which the disclosure pertains from the following description.

What is claimed is:

1. An electronic device for generating a corrected image, the electronic device comprising:
memory storing at least one instruction; and
at least one processor comprising a processing circuitry;
wherein the at least one processor is configured to individually or collectively execute the at least one instruction stored in the memory to:
obtain an input image corresponding to a first area and a second area adjacent to the first area, and a frame image corresponding to the second area;
based on the input image and the frame image, generate a masking map comprising information about an object of interest displayed in the second area of the input image; and
generate the corrected image based on the masking map by adding the input image and the frame image,
wherein the corrected image includes the input image in the first area and including the object of interest and the frame image in the second area.

2. The electronic device of claim 1, further comprising an image display comprising a display area,
wherein the first area and the second area are included in the display area, and
wherein the at least one instruction further causes the electronic device to display the generated corrected image in the display area.

3. The electronic device of claim 1, wherein the at least one instruction further causes the electronic device to:
based on the input image, obtain a depth map comprising depth information associated with the input image;
based on the input image, obtain a saliency map comprising saliency information associated with the input image; and
based on the frame image, the depth map, and the saliency map, extract the object of interest from the input image.

4. The electronic device of claim 3, wherein the at least one instruction further causes the electronic device to:
based on the saliency map and the frame image, extract an object from among at least one object included in the input image as an object-of-interest candidate based on determining that a saliency value of the object is greater than a predetermined first value and that the object corresponds to the second area; and
based on the depth map, extract the object-of-interest candidate as the object of interest based on determining that a depth value of the object-of-interest candidate is greater than a predetermined second value.

5. The electronic device of claim 3, wherein the first area has a first resolution and the input image has an input resolution, and
wherein the at least one instruction further causes the electronic device to:
based on the object of interest, calculate a reduction ratio for lowering the input resolution of the input image; and
generate the masking map based on the reduction ratio, the frame image, and the object of interest.

6. The electronic device of claim 5, wherein the at least one instruction further causes the electronic device to:
based on the reduction ratio, generate a reduced input image by lowering the input resolution of the input image; and
generate the corrected image by adding the reduced input image and the frame image based on the masking map.

7. The electronic device of claim 6, wherein the input resolution is greater than the first resolution, and
wherein a resolution of the reduced input image is equal to or greater than the first resolution.

8. The electronic device of claim 6, wherein the masking map is generated to mask each of the reduced input image and the frame image, in order to generate the corrected image including the reduced input image in the first area and including the frame image in the second area.

9. The electronic device of claim 1, wherein the at least one instruction further causes the electronic device to:
based on the input image, obtain motion information by estimating a movement of the input image;
based on the obtained motion information, extract a moving object from the input image;
calculate an expected location of the moving object in a next frame; and
based on determining that the calculated expected location is included in the second area, generate a movement corrected image including the moving object positioned at the expected location on the second area of the corrected image, based on the corrected image and the moving object.

10. The electronic device of claim 9, wherein the at least one instruction further causes the electronic device to:
calculate a size of at least one object included in the input image; and
based on the motion information and the size of the at least one object, extract an object from among the at least one object as the moving object based on determining that a size of the object is smaller than a predetermined third value.

11. An method for generating a corrected image using an electronic device, the method comprising:
obtaining an input image corresponding to a first area and a second area adjacent to the first area, and a frame image corresponding to the second area;
based on the input image and the frame image, generating a masking map comprising information about an object of interest displayed in the second area of the input image; and
generating the corrected image based on the masking map by adding the input image and the frame image,
wherein the corrected image includes the input image in the first area, and including the object of interest and the frame image in the second area.

12. The method of claim 11, further comprising displaying the generated corrected image on a display area using an image display including the display area,
wherein the first area and the second area are included in the display area.

13. The method of claim 11, further comprising:
based on the input image, obtaining a depth map comprising depth information associated with the input image;
based on the input image, obtaining a saliency map comprising saliency information associated with the input image; and
based on the frame image, the depth map, and the saliency map, extracting the object of interest from the input image.

14. The method of claim 13, wherein the extracting of the object of interest further comprises:
based on the saliency map and the frame image, extracting an object from among at least one object included in the input image as an object-of-interest candidate based on determining that a saliency value of the object is greater than a predetermined first value and that the object corresponds to the second area; and
based on the depth map, extracting the object-of-interest candidate as the object of interest based on determining that a depth value of the object-of-interest candidate is greater than a predetermined second value.

15. The method of claim 13, wherein the first area has a first resolution, and the input image has an input resolution,
wherein the method further comprises, based on the object of interest, calculating a reduction ratio for lowering the input resolution of the input image, and
wherein the masking map is generated based on the reduction ratio, the frame image, and the object of interest.

16. The method of claim 15, wherein the method further comprises, based on the reduction ratio, generating a reduced input image by lowering the input resolution of the input image, and
wherein the corrected image may be generated by adding the reduced input image and the frame image, based on the masking map.

17. The method of claim 16, wherein the masking map is generated to mask each of the reduced input image and the frame image, in order to generate the corrected image including the reduced input image on the first area and including the frame image on the second area.

18. The method of claim 11, further comprising:
based on the input image, obtaining motion information by estimating a movement of the input image;
based on the obtained motion information, extracting a moving object from the input image;
calculating an expected location of the moving object in a next frame; and
based on determining that the calculated expected location is included in the second area, generating a movement corrected image including the moving object positioned at the expected location on the second area of the corrected image, based on the corrected image and the moving object.

19. The method of claim 18, wherein the extracting of the moving object comprises:
calculating a size of at least one object included in the input image; and
based on the motion information and the size of the at least one object, extracting an object from among the at least one object as the moving object based on determining that a size of the object is smaller than a predetermined third value.

20. A computer-readable recording medium having recorded thereon a computer program including instructions, which, when executed by at least one processor of an electronic device for generating a corrected image, causes the electronic device to:
obtain an input image corresponding to a first area and a second area adjacent to the first area, and a frame image corresponding to the second area;
based on the input image and the frame image, generate a masking map comprising information about an object of interest displayed in the second area of the input image; and
generate the corrected image based on the masking map by adding the input image and the frame image,
wherein the corrected image includes the input image in the first area, and including the object of interest and the frame image in the second area.
